(19) United States
(12) Patent Application Publication
(10) Pub. No.: US 2024/0243574 A1
(43) Pub. Date: Jul. 18, 2024

(54) Method and System For Predicting An Energy-Related Metric of a Building

(71) Applicant: Winston L. MORTON, Porters Lake (CA)

(72) Inventor: Winston L. MORTON, Porters Lake (CA)

(73) Assignee: Climatve Inc., (omitted)

(21) Appl. No.: 18/165,437

(22) Filed: Feb. 7, 2023

Related U.S. Application Data
(60) Provisional application No. 63/481,597, filed on Jan. 25, 2023.
(60) Provisional application No. 63/480,284, filed on Jan. 17, 2023.

(51) Int. Cl. H02J 3/00

(52) U.S. Cl. CPC H02J 3/003

(57) ABSTRACT

Methods and systems for predicting energy-related metrics of a building are provided, including creating and selecting models for recommending a building upgrade and predicting energy savings based on a recommended building upgrade. Automate building energy efficiency evaluations and do not require input by the building owner. Without participation of building owners or the need for onsite home energy performance evaluations, energy metrics and upgrade recommendations can be quickly and automatically provided to many homeowners.

### RELATED APPLICATIONS

This application claims the benefit under 35 U.S.C. § 119(e) to U.S. Provisional Application Ser. No. 63/481,597, titled “Method and System For Predicting An Energy-Related Metric of a Building”, filed on Jan. 25, 2023, and to U.S. Provisional Application Ser. No. 63/480,284, titled “Auditable Building Ledger Method and System”, filed on Jan. 17, 2023, both of which are herein incorporated by reference in their entirety.

### BACKGROUND

One significant contributor to climate change is the generation of electricity. Most electricity is generated by burning fossil fuels which supplies a large portion of global emissions. Little more than 25% of electricity of renewable energy sources emit little to no greenhouse gases (GHGs) or pollutants into the air.

Another significant contributor to climate change is powering, heating, and cooling residential and commercial buildings. Globally, residential, and commercial buildings consume over half of all electricity generated. Furthermore, many buildings rely on coal, oil, and natural gas for heating and cooling, which also emits significant quantities of greenhouse gas emissions.

Growing energy demand for heating and cooling, with rising air-conditioner ownership, as well as increased electricity consumption for lighting, appliances, and connected devices, has contributed to a rise in energy-related carbon-dioxide emissions from buildings in recent years.

According to the United Nations to preserve a livable climate, GHG emissions must be reduced by half by 2030 and to net zero by 2050. To achieve this ambitious goal, fast and dramatic action by governments, businesses and the world's citizens is needed.

### SUMMARY

According to an embodiment there is provided a method for predicting an energy-related metric for a building comprising, processing building-related data corresponding to a building and boundary data corresponding to a first plurality of service regions for selecting a second plurality of service regions therefrom, the second plurality of service regions corresponding to the building, selecting a present service region from the second plurality of service regions based on the present service region having an area smaller in size in comparison to an area of other service regions of the second plurality of service regions, for each model family of a plurality of model families including a first subset of models corresponding to the present service region, provided final model data corresponding to the model family other than exists, creating final model data including final model ID data indicative of a final model ID and final model score data indicative of a score of the final model, the final model ID data and final model score data indicating a value of 0, selecting a second subset of models from the first subset of models based on the building-related data meeting input criteria of each thereof, selecting a first model from the second subset of models based on a model score of the first model having a greater value compared to a model score of other models of the second subset of models, provided the model score of the first model exceeds final score model data, modifying final model data including modifying final model ID data to be same as model ID data corresponding to the first model and final model score data to be same as model score data corresponding to the first model, provided a next service region of the second plurality of service regions has an area subsequently larger in size in comparison to an area of the present service region, modifying the present service region to be same as the next service region and reiterating steps c and d) and for each final model corresponding to each model family of the plurality of model families, processing building-related data by the final model, the final model for predicting an energy-related metric for a building comprising and for each final model corresponding to each model family of the plurality of model families, providing an indication of a prediction of an energy-related metric for the building. Processing building-related data corresponding to a building and boundary data corresponding to a first plurality of service regions for selecting a second plurality of service regions therefrom may include processing building-related data including an indication of a location of the building. Predicting an energy-related metric of a building includes at least one of recommending a building upgrade and predicting an energy characteristic of a building.

According to another embodiment there is provided a method for predicting an energy-related metric for a building comprising, processing building-related data corresponding to a building and boundary data corresponding to a first plurality of service regions for selecting a second plurality of service regions therefrom, the second plurality of service regions corresponding to the building, selecting a present service region from the second plurality of service regions based on the present service region having an area smaller in size in comparison to an area of other service regions of the second plurality of service regions, for each model family corresponding to the second plurality of service regions, creating final model data including final model ID data indicative of a final model ID and final model score data indicative of a score of the final model, the final model ID data and final model score data indicating a value of 0, for each model family of a plurality of model families including a first subset of models corresponding to the present service region, selecting a second subset of models from the first subset of models based on the building-related data meeting input criteria of each thereof, selecting a first model from the second subset of models based on a model score of the first model having a greater value compared to a model score of other models of the second subset of models, provided the model score of the first model exceeds final score model data, modifying final model data including modifying final model ID data to be same as model ID data corresponding to the first model and final model score data to be same as model score data corresponding to the first model, provided a next service region of the second plurality of service regions has an area subsequently larger in size in comparison to an area of the present service region, modifying the present service region to be same as the next service region and reiterating steps c and d), and for each final model corresponding to each model family of the plurality of model families, processing building-related data by the final model, the final model for predicting an energy-related metric for a building comprising, and for each final model corresponding to each model family of the plurality of model families, providing an indication of a prediction of an energy-related metric for the building.

According to an embodiment there is provided a system configured for predicting an energy-related metric for a building comprising, processing building-related data corresponding to a building and boundary data corresponding to a first plurality of service regions for selecting a second plurality of service regions therefrom, the second plurality of service regions corresponding to the building, selecting a present service region from the second plurality of service regions based on the present service region having an area smaller in size in comparison to an area of other service regions of the second plurality of service regions, for each model family corresponding to the second plurality of service regions, creating final model data including final model ID data indicative of a final model ID and final model score data indicative of a score of the final model, the final model ID data and final model score data indicating a value of 0, for each model family of a plurality of model families including a first subset of models corresponding to the present service region, selecting a second subset of models from the first subset of models based on the building-related data meeting input criteria of each thereof, selecting a first model from the second subset of models based on a model score of the first model having a greater value compared to a model score of other models of the second subset of models, provided the model score of the first model exceeds final score model data, modifying final model data including modifying final model ID data to be same as model ID data corresponding to the first model and final model score data to be same as model score data corresponding to the first model, provided a next service region of the second plurality of service regions has an area subsequently larger in size in comparison to an area of the present service region, modifying the present service region to be same as the next service region and reiterating steps c and d), and for each final model corresponding to each model family of the plurality of model families, processing building-related data by the final model, the final model for predicting an energy-related metric for a building comprising, and for each final model corresponding to each model family of the plurality of model families, providing an indication of a prediction of an energy-related metric for the building.

### BRIEF DESCRIPTION OF FIGURES

Embodiments of the invention are now described by way of non-limiting example and are illustrated in the following figures in which like reference numbers indicate like features, and wherein:

FIG. 1A is simplified flow diagram of a prior art process for a building owner to improve energy efficiency of their building.

FIG. 1B is a conceptual diagram of parties involved with providing building upgrade recommendations and providing information regarding rebates and other offers related to improving home efficiency.

FIG. 2 is a simplified block diagram of a system for training a model.

FIG. 3 is simplified flow diagram of a method for training a plurality of building energy analysis model.

FIG. 4 is a conceptual diagram of boundary data corresponding to a plurality of service regions.

FIG. 5A is a visual representation of a plurality of service regions.

FIG. 5B is a visual representation of a plurality of service regions.

FIG. 5C is a visual representation of another of service region.

FIG. 6 illustrates exemplary types of building-related data.

FIG. 7A is a table of exemplary service region data, corresponding area data, corresponding model family ID data, model ID data, model score data and model input criteria data.

FIG. 7B is another table of exemplary service region data, corresponding area data, corresponding model family ID data, model ID data, model score data and model input criteria data.

FIG. 7C is another table of exemplary service region data, corresponding area data, corresponding model family ID data, model ID data, model score data and model input criteria data.

FIG. 8A is a simplified diagram of an exemplary network configuration within which some embodiments may operate.

FIG. 8B is simplified flow diagram of an exemplary process for predicting energy-related metric of a building.

FIG. 9A is another simplified flow diagram of an exemplary process for predicting energy-related metric of a building.

FIG. 9B illustrates exemplary final models.

FIG. 9C illustrates exemplary building-related data.

FIG. 9D is another simplified flow diagram of an exemplary process for predicting energy-related metric of a building.

FIG. 10 is another simplified flow diagram of an exemplary process for predicting energy-related metric of a building.

FIG. 11 is another simplified flow diagram of an exemplary process for predicting energy-related metric of a building.

### DETAILED DESCRIPTION

The public can implement simple strategies to reduce energy consumption of homes and buildings such as, replacing old appliances with newer more energy efficient appliances, swapping out traditional light bulbs for LED bulbs, installing low water showerheads, unplugging smaller appliances/TVs/computers/gaming consoles when not in use, and washing clothes in cold water.

A not-so-simple strategy to reduce energy consumption of a building is to improve its energy efficiency. To take steps to improve energy efficiency of a building, the building owner must first know the areas of the building that are causing energy waste problems. Prior to implementing any costly material changes to the building, or replacing an expensive HVAC or water heating system, a building owner commonly hires a professional energy advisor to perform an onsite energy assessment of their building. An energy advisor has specialized training to measure and evaluate the flow of energy to determine if it is being used efficiently and pinpoint where it is being wasted.

### Process 100

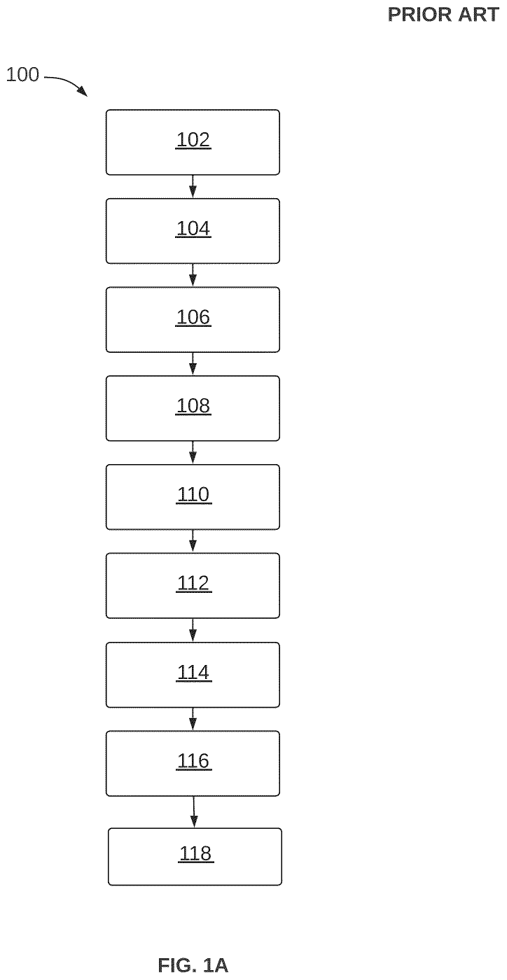

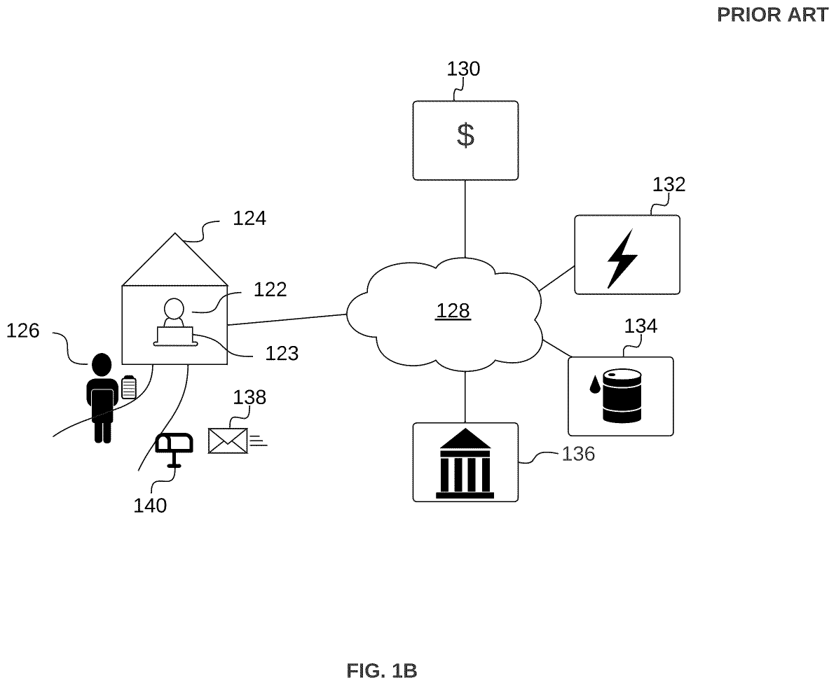

Shown in FIG. 1A is a prior art method 100 for a building owner to improve energy efficiency of their building. Method 100 is described below with reference to FIG. 1A and FIG. 1B. FIG. 1B illustrates a diagrammatic view of building owner 122, the building owner's computer 123, building 124, energy advisor 126 and various influencers that may influence method 100, such as financial institution 130, (e.g., bank), electricity provider 132, gas provider 134, (i.e., natural gas, oil), and government organization 136. FIG. 1B also includes communication network 128, such as the Internet, communicatively coupling computer 123 with financial institution 130, electricity provider 132, gas provider 134, and government organization 136. Finally, FIG. 1B shows mail 138 which may be mailed to the post box 140 of building 124 from one or more of financial institution 130, electricity provider 132, gas provider 134, and government organization 136.

At block 102, process 100 includes a building owner booking an onsite energy assessment appointment with an energy advisor.

In this example, building 124 is a residential home owned by homeowner 122. Homeowner 122 contacts energy advisor 126, for instance, a Natural Resources Canada (NRCan) licensed service provider, to book an onsite energy assessment of their home, also known as an EnerGuide® energy efficiency home evaluation.

At block 104, process 100 includes a delay.

For example, appointments for an EnerGuide® energy efficiency home evaluation with an energy advisor is usually not available immediately and are booked months in advance of the actual assessment. For instance, homeowner 122 may wait months after the assessment is booked for an energy advisor to visit their home and perform an onsite energy assessment.

At block 106, process 100 includes an energy advisor performing an onsite energy assessment.

For example, energy advisor 126 visits home 124 and performs an EnerGuide® energy efficiency home evaluation of home 124.

In this example, energy advisor 126 analyzes specific elements that contribute to the overall efficiency of home 124. For instance, analyzing heating and cooling systems, or HVAC system, and insulation levels, including the basement and exterior attic walls, measuring and counting the number of doors and windows of home 124. Energy advisor 126 also performs an airtightness test for determining how tight the envelope of home 124 is by checking for air leakage thereof. Energy advisor 126 may assess the energy consumption of home 124 by conducting a thermographic scan, and/or by using other equipment to measure energy consumption, such as, infrared cameras, surface thermometers, and ceiling efficiency meters. In some cases, energy advisor 126 also analyzes past utility bills.

Next, at block 108, once the building has been evaluated and testing has been completed, the energy advisor inputs data collected during their visit into specialized building energy assessment software, such as, HOT2000™ or EnergyPlus™, to analyze the energy performance of the many components of the building. This software provides estimates of energy characteristics of the building, such as the current energy consumption of the building, the current amount of energy used for heating the building and the amount of heat loss of the building's features/components, as well as estimates of possible energy savings due to various building upgrades. The energy advisor reviews outputs of the software and creates a thorough list of upgrade recommendations including estimates of energy savings should the upgrade be implemented.

Next, at block 110, process 100 includes yet another delay.

For example, months may pass before energy advisor 126 completes their final home energy assessment report and provides a copy to homeowner 122.

At block 112, process 100 includes the energy advisor providing the building owner a final home energy assessment report including a list of energy efficiency improvements, i.e., upgrade recommendations, and energy savings should the upgrades be implemented. Improved energy efficiency of the building will most likely cause a decrease in monthly utility/heating bills.

For example, energy advisor 126 may provide a list of upgrades including replacement of 3 windows with ENERGY STAR® windows and replacing an old oil ceiling with a gas ceiling. Implementing the window and ceiling upgrades would have an annual energy savings of 10 GJ and 10 MJ, respectively. The ENERGY STAR® symbol is an internationally recognized mark of high efficiency. A product, home, building, or industrial facility having an ENERGY STAR® mark is certified to use less energy and reduce emissions that contribute to climate change.

At block 114, the building owner searches for upgrade related rebates or offers from various organizations.

For example, homeowner 122 visits websites of financial institution 130, electricity provider 132, gas provider 134, and government organization 136 searching for upgrade-related rebates/offers. Alternatively, and/or in additionally, homeowner 122 searches through bulk email and/or mail received from one or more of financial institution 130, electricity provider 132, gas provider 134, and government organization 136, for upgrade-related rebates/offers.

At block 116, the building owner manually evaluates upgrade recommendations provided by the energy advisor and upgrade-related rebates or offers from the various organizations.

For example, homeowner 122 may review all upgrade rebate and/or offers from one or more of financial institution 130, electricity provider 132, gas provider 134, and government organization 136 to determine whether rebates, offers and/or low-rate loans for upgrading a home are available should they decide to upgrade their windows and/or ceiling.

A homeowner independently reviewing upgrade rebate/offers without the assistance of an energy advisor may be unaware of the effect of implementing one upgrade on another upgrade. For example, a homeowner may upgrade insulation of their home because a rebate for insulation was available. The same homeowner may also decide to upgrade their ceiling because an offer subsidizing purchase of a new ceiling was also available. However, the effect of upgrading their home's insulation has a large impact on the energy/heat loss of the house envelope. As a result, the old ceiling would not have to work so hard and thus the purchase of a new ceiling would provide a low return on investment.

Furthermore, upgrades to a home are often equated to a potential energy savings. However, information provided via various home upgrade rebates/offers by different service providers do not have a common format for explaining potential energy savings. For example, a first upgrade rebate/offer provided by a first service provider may provide information regarding potential energy savings in MJ. In contrast, a second upgrade rebate/offer provided by a second service provider may provide information regarding potential energy savings in the number of trees saved and/or planted.

Finally, at block 118, the building owner decides whether to implement one or more recommended upgrades.

For example, homeowner 122 replaces 3 windows with ENERGY STAR® windows and applies for a 40% rebate available by government organization 136. However, homeowner 122 was unable to find any rebates/offers for replacing their old oil ceiling with a new gas ceiling. Although homeowner 122 was unable to find any rebates/offers this does not mean rebates/offers were not available. Homeowner 122 could not afford to purchase a new gas ceiling at full price and thus did not implement that recommended upgrade.

Process 100 illustrates challenges homeowners face when they wish to upgrade their homes to reduce energy wastage. In North America only 1.5% of residential buildings are retrofitted annually and only 10% of buildings have been evaluated over the last 20 years. Currently, existing buildings make up to 18% of GHG emissions. A quicker process in comparison to process 100 for providing similar information as provided in a home energy assessment report (e.g., energy consumption of home elements, upgrade recommendations, predicted energy savings due to implementing upgrades, etc.) and on a larger scale (e.g., for many homeowners in a short period of time) may accelerate the retrofit of a larger number of buildings annually, thus reducing the amount of GHG emissions caused thereby.

According to an embodiment, there is a method for creating a building energy analysis model corresponding to a predefined region, also referred to herein, as a service region.

According to an embodiment a building energy analysis model processes building-related data associated with a building corresponding to a service region for predicting an energy characteristic thereof. Alternatively, a building analysis model processes building-related data associated with a building corresponding to a service region for providing a recommendation of an upgrade for the building. Alternatively, the building analysis model processes building-related data associated with a building corresponding to a service region for predicting another energy-related metric of a building.

Specific and non-limiting examples of a predefined region includes a city, province, state, country, or other service region, such as an area serviced by, for example, a gas utility.

A model for predicting an energy characteristic of a building includes a model for predicting an energy characteristic of a building prior to implementation of an upgrade to the building (pre-upgrade). Specific and non-limiting examples of a model predicting an energy characteristic of a building prior an implemented upgrade to the building (pre-upgrade) includes a model for predicting the total energy consumption of a building prior to an implementation of any upgrades, for example, in megajoules (MJ), a model for predicting electricity consumption of a building in kWh, gas consumption of a building in m3, oil consumption of a building in L, propane consumption by a building in L, heating energy consumption of a building in MJ, heat lost through foundation of a building in MJ, heat loss through walls of a building in MJ, among others.

A model for predicting an energy characteristic of a building includes a model for predicting an energy characteristic of a building after implementation of an upgrade to the building (post-upgrade). Specific and non-limiting examples of a model predicting an energy characteristic of a building after an upgrade to a building is implemented (post-upgrade) includes a model for predicting the total energy consumption of a building after an implementation of any upgrades, for example, in megajoules (MJ), a model for predicting electricity consumption of a building after an implementation of any upgrades in kWh, gas consumption of a building after an implementation of any upgrades in m3, (for example, after an oil ceiling is replaced by a natural gas ceiling), oil consumption of a building after an implementation of any upgrades in L, propane consumption by a building after an implementation of any upgrades in L, heating energy consumption of a building after an implementation of any upgrades in MJ, (for example, after a ceiling is upgraded, and/or after wall insulation is upgraded, and/or after ceiling insulation is upgraded, etc.), heat lost through foundation of a building after the foundation is upgraded in MJ, heat loss through walls of a building after insulation in walls is upgraded in MJ, among others.

In some instances, a model for predicting an energy characteristic of a building includes a model for predicting energy savings if a building receives an upgrade. Specific and non-limiting examples of a model for predicting energy savings if a building receives an upgrade includes a model for predicting window and door upgrade energy savings in MJ (e.g., energy savings due to the upgrade of the building's doors and windows to EnerStar® doors and windows), a model for predicting insulation energy upgrade savings in MJ (e.g., the energy savings due to the upgrade of the building's insulation (i.e., increased RSI value)), a model for predicting ceiling energy upgrade savings in MJ (e.g., the energy savings due the upgrade of the ceilings (i.e., upgrade of insulation in ceiling), among others.

Specific and non-limiting examples of a model for recommending an upgrade for a building includes a model for recommending upgrading a building's insulation, a model for recommending upgrading a building's windows and doors, a model for recommending upgrading a building's ceiling, a model for recommending upgrading a building's foundation, among others. In some instances, a model for recommending an upgrade for a building provides a binary value, for example, a model outputs 0 to indicate an upgrade for a building is not recommended and outputs 1 to indicate an upgrade for a building is recommended.

For example, a model for recommending upgrading a building's insulation is dependent on the output of an insulation energy upgrade savings model. If the model outputs an energy savings equal to or above, for example, 5 MJ, the model for recommending upgrading a building's insulation will provide a value of 1, indicating upgrading the building's insulation is recommended. In this example, if the output of an insulation energy upgrade savings model is less than 5 MJ, the model for recommending upgrading the building's insulation will provide a value of 0, indicating upgrading the building's insulation is not recommended.

According to an embodiment, a method for creating a building energy analysis model corresponding to a predefined region includes creating a plurality of building energy analysis models predicting a same energy-related metric of the building corresponding to a predefined region. In a first instance, the plurality of building energy analysis models includes a plurality of models predicting a same energy characteristic of a building. For example, the plurality of building energy analysis models corresponds to a plurality of models that each predict the total energy consumption of a same building. In a second instance the plurality of building energy analysis models includes a plurality of models for recommending a same upgrade for a same building. For example, the plurality of building energy analysis models corresponds to a plurality of models that each provides a recommendation for upgrading the foundation of a same building. In yet another instance, the plurality of building energy analysis models includes a plurality of models for predicting another same energy-related metric of a same building.

According to an embodiment, a method for creating a plurality of building energy analysis models predicting a same energy-related metric of a building corresponding to a predefined region includes assigning a score to each thereof. Relative scores of the plurality of models serves as guide for selecting a model from the plurality of models.

In a first example, accuracy of each of the plurality of models is compared and scored relatively. For instance, the model with the lowest score is the least accurate model in the plurality of models. The model with the next incrementally higher score corresponds to the model with the next incrementally better accuracy, as so on.

In a second example, data sensitivity of each of the plurality of models is compared and scored relatively. For instance, the model with the lowest score is the most sensitive model of the plurality of models. The model with the next incrementally higher score is incrementally less sensitive in comparison, and so on.

In a third example, runtime performance of each model of the plurality of models is scored relatively. For instance, the model with the lowest score corresponds to the model with the longest execution runtime. The model with the next incrementally higher score has an incrementally shorter execution runtime, and so on.

Alternatively, a score of a model is based on another model metric. Further, a score of a model is based on a combination of model metrics.

According to an embodiment, a method for creating a plurality of building energy analysis models predicting a same energy-related metric of a building corresponding to a service region includes assigning an input data criteria to each thereof. Input data criteria indicates criteria of input data required to employ the corresponding model.

For example, an exemplary method for generating a plurality of building energy analysis models in the form of a plurality of models for predicting for the total energy consumption of a building corresponding to a first service region includes creating 3 models. In this example, 3 models corresponding to a first service region are created including model 1, model 2 and model 3. Model 1, model 2 and model 3 are assigned scores 10, 20 and 30 respectively. Furthermore, model 1, model 2 and model 3 have associated input data criteria, input data X, input data X+Y, input data X+Y+Z, respectively.

In this example, model 3 is assigned the highest score. As such, model 3 should be selected from the plurality of models for predicting for the total energy consumption of the building provided input data meets the input data criteria corresponding to model 3. In other words, model 3 should be selected if input data X+Y+Z is available.

If input data X+Y+Z is not available, model 2 having the next best score to model 3 should be used for predicting the total energy consumption of a building provided input data meets the input data criteria corresponding to model 2, input data X+Y.

If input data X+Y is not available, model 1 having the next best score to model 2 should be used for predicting the total energy consumption of a building provided input data meets the input data criteria corresponding to model 1, input data X.

If input data X is not available, in other words input data does not meet any of the criteria of model 1, model 2 or model 3, no model may be used for predicting the total energy consumption of the building.

An exemplary method for creating a building energy analysis model corresponding to a predefined region including creating a plurality of building energy analysis models predicting a same energy-related metric of the building corresponding to a predefined region is described in an example below.

### Process 300

According to an embodiment there is an exemplary method for creating a plurality of building energy analysis models predicting a same energy-related metric of a building corresponding to a predefined region.

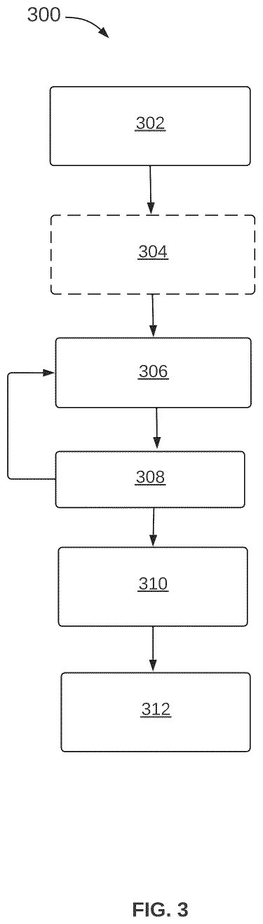

A simplified flow diagram of exemplary method 300 for generating a model for creating a plurality of building energy analysis models is shown in FIG. 3.

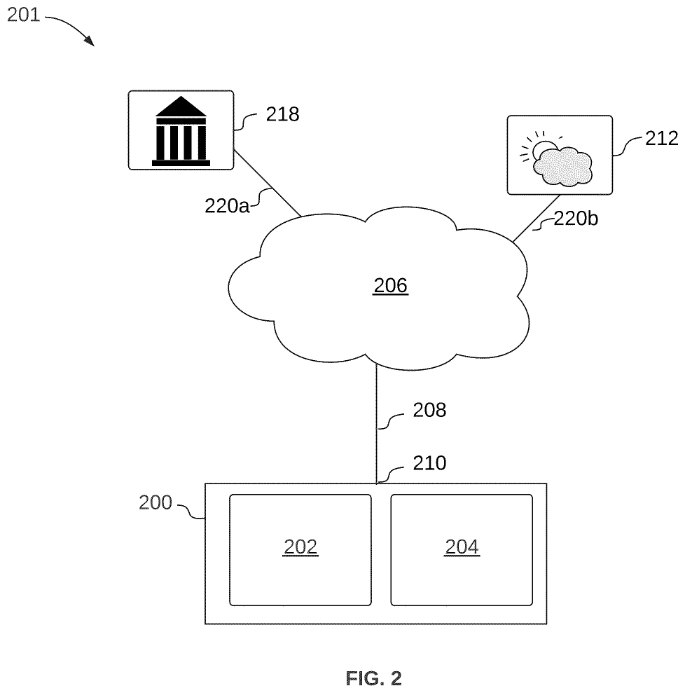

Illustrated in FIG. 2 is a simplified diagram of an exemplary network configuration 201 within which some embodiments may operate. Network configuration 201 includes system 200, remote servers 218 and 212, and communication network 206, such as the Internet. Communication network 206 may be communicatively coupled to system 200 and remote servers 218 and 212 enabling communication therebetween. For example, system 200 may be communicatively coupled to communication network 206 via communication link 208. Remote servers 218 and 212 may be communicatively coupled to communication network 206 via communication links 220a and 220b, respectively. As such, system 200 may communicate with remote servers 218 and 212.

Communication network 206 may include one or more computing systems and may be any suitable combination of networks or portions thereof to facilitate communication between network components. Some examples of networks include, Wide Area Networks (WANs), Local Area Networks (LANs), Wireless Wide Area Networks (WWANs), data networks, cellular networks, voice networks, among other networks, which may be wired and/or wireless. Communication network 206 may operate according to one or more communication protocols, such as, General Packet Radio Service (GPRS), Universal Mobile Telecommunications Service (UMTS), GSM, Enhanced Data Rates for GSM Evolution (EDGE), LTE, CDMA, LPWAN, Wi-Fi, Bluetooth, Ethernet, HTTP/S, TCP, and CoAP/DTLS, or other suitable protocol. Communication network 206 may take other forms as well.

System 200 includes processing resource 202, datastore 204 and network interface 210.

Process 300 is described as carried out by system 200 shown in FIG. 2. Alternatively, process 300 may be carried out by another system, a combination of other systems, subsystems, devices or other suitable means provided the operations described herein are performed. Process 300 may be automated, semi-automated and some blocks thereof may be manually performed.

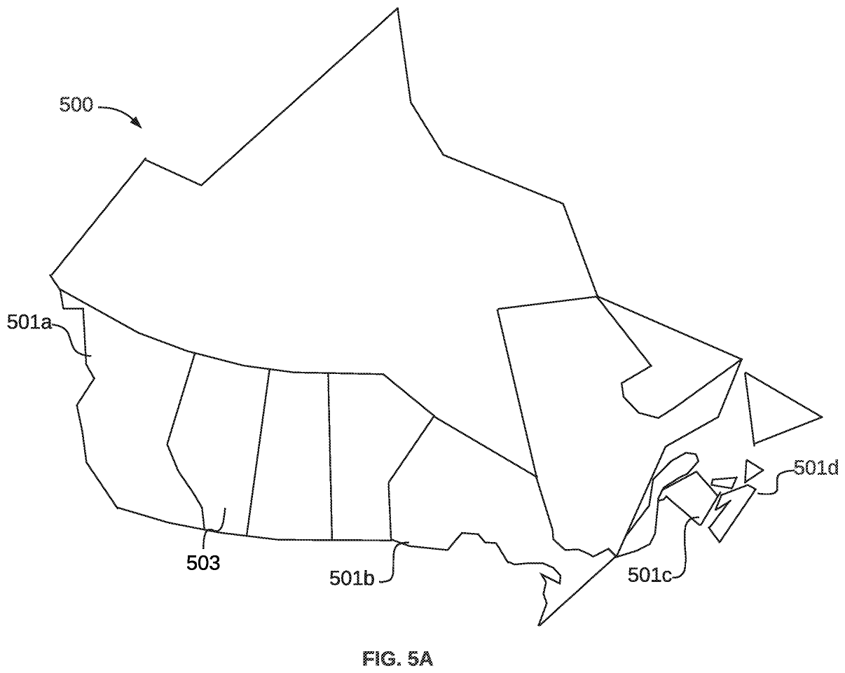

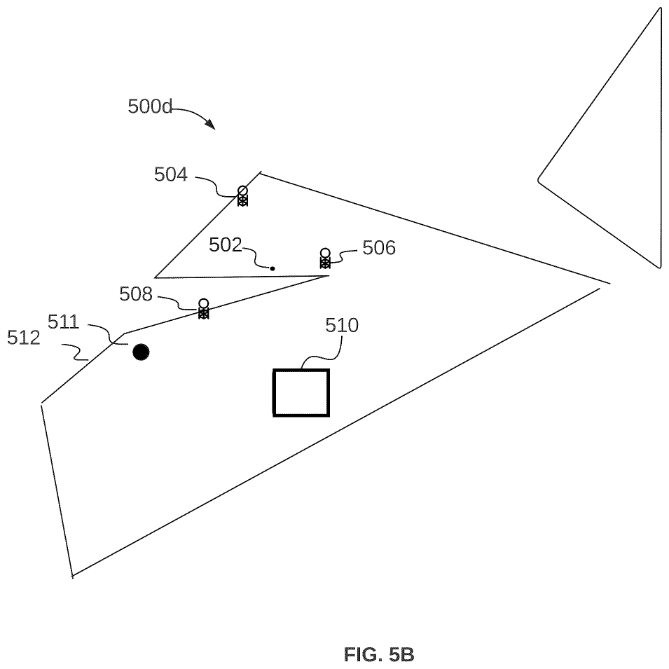

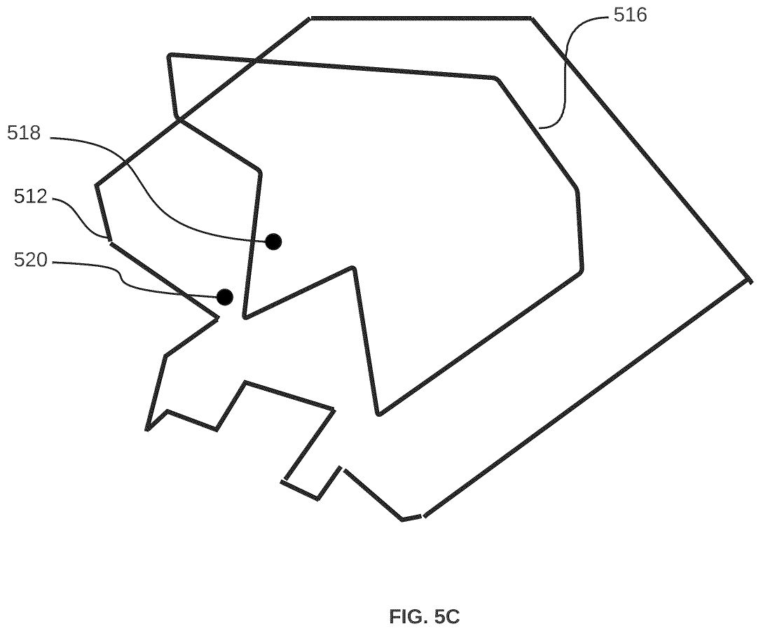

Process 300 is described below with reference to FIG. 2, FIG. 3, and FIG. 5B.

Starting at block 302, process 300 includes receiving building-related data associated with a plurality of buildings corresponding to a first service region.

For example, building-related data, in the form of onsite energy assessment data associated with a plurality of buildings corresponding to a first service region, in the form of Nova Scotia, is received by system 200.

Exemplary onsite energy assessment data includes data input into building energy assessment software, such as data measured and recorded by an energy advisor during an onsite energy assessment of a building, and output data from the building energy assessment software and/or data derived therefrom. Specific and non-limiting examples of building energy assessment software includes HOT2000™ and EnergyPlus™.

In this example, system 200 receives onsite energy assessment data for a plurality of residential homes located in exemplary service region Nova Scotia 500d shown in FIG. 5B.

For instance, remote server 218 is a government of Canada server storing onsite energy assessment data for homes located in Canadian provinces including first service region Nova Scotia. In this example, system 200 receives from server 218 onsite energy assessment data for 2000 homes located in service region Nova Scotia 500d, and stores it, for example, in datastore 204.

In the present example, Canadian energy advisors provide onsite energy assessment data from home energy assessments they have performed to the Canadian government, which is stored on server 218 and accessible to the public via the Internet. In this example onsite energy assessment data includes the full street address of each home. In some instances, for the purpose of maintaining a homeowner's privacy, onsite energy assessment data does not include the full street address of each home, instead it includes a corresponding forward sortation area (FSA) code to indicate a home's general location. An FSA is a way to designate a geographical unit based on the first three characters in a Canadian postal code.

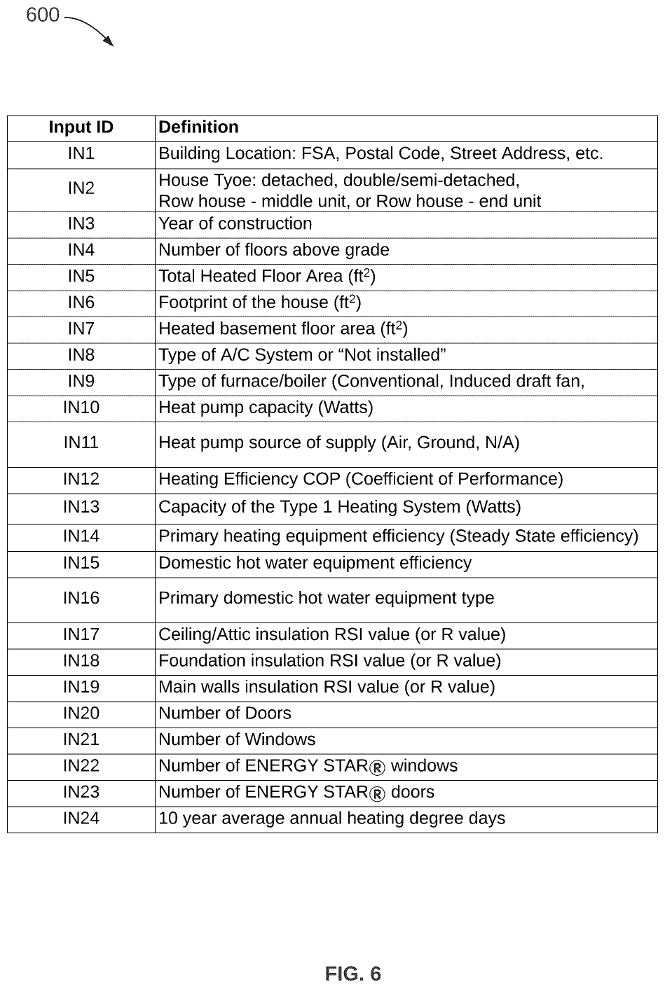

Exemplary onsite energy assessment data includes input data to building energy assessment software and output data from building energy assessment software. Exemplary input data of building energy assessment software is shown in table 600 of FIG. 6, including, IN1 to IN23.

Exemplary output data output from building energy assessment software may include estimates of energy characteristics of a building and predicted energy savings if a recommended upgrade is implemented.

Exemplary output data of building energy assessment software is shown in Table 1 below.

TABLE 1
Exemplary building energy assessment software Output Data
Exemplary Building Energy Assessment Software Output Data

Total Home Energy Consumption data
Heating Energy Consumption data
Window and Door Upgrade Energy Savings data
Insulation Upgrade Energy Savings data
Ceiling Upgrade Energy Savings data

Other exemplary output data of building energy assessment software will be apparent to persons skilled in the art.

In the present example, Total Home Energy Consumption data indicates an estimate of the total energy consumed by a home, Heating Energy Consumption data indicates an estimate of the total energy used by a home for the purposes of heating the home, Window and Door Upgrade Energy Savings data indicates an estimate of the energy that could be saved if a window and door upgrade was implemented, Insulation Upgrade Energy Savings data indicates an estimate of the energy that could be saved if an insulation upgrade was implemented, and Ceiling Upgrade Energy Savings data indicates an estimate of the energy that could be saved if a ceiling upgrade was implemented.

Exemplary data derived from building energy assessment software includes Window and Door Upgrade data, Insulation Upgrade data and Ceiling Upgrade data. For example, Window and Door Upgrade data is derived from Window and Door Upgrade Energy Savings data.

In a first instance, Window and Door Upgrade data has a value of 1 if Window and Door Upgrade Energy Savings data is 5 MJ or greater and has a value of 0 if Window and Door Upgrade Energy Savings data is less than 5 MJ. In a second instance, Insulation Upgrade data is derived from Insulation Upgrade Energy Savings data has a value of 1 if Insulation Upgrade Energy Savings data is 20 MJ or greater and has a value of 0 if Insulation Upgrade Energy Savings data is less than 20 MJ. In a third instance, Ceiling Upgrade data is derived from Ceiling Upgrade Energy Savings data has a value of 1 if Ceiling Upgrade Energy Savings data is 20 MJ or greater and has a value of 0 if Ceiling Upgrade Energy Savings data is less than 20 MJ.

Next, at optional block 304, process 300 includes receiving other building-related data associated with each building of the plurality of buildings corresponding to the first service region.

For example, system 200 determines the LAT, LONG coordinates of weather stations in each service region and stores data indicative of a unique weather station ID and LAT, LONG coordinates of each thereof, for example, in datastore 204, for future use.

For example, system 200 processes onsite energy assessment data associated with each home of the plurality of residential homes corresponding to service region Nova Scotia 500d for determining a location thereof. Next, system 200 identifies the closest weather station to each home and receives historical weather data therefrom.

In a first instance, system 200 processes first onsite energy assessment data corresponding to home 502 shown in FIG. 5B. The civic address of home 502 is 3250 Foxisland Drive, Economy, NS, BOM 1J0.

Next, system 200 converts the civic address of home 502 into LAT, LONG coordinates. For instance, 3250 Foxisland Drive, Economy, NS, BOM 1J0 is located at (45.382850, −63.906053).

In some instances, only an FSA is included in onsite energy assessment data. In such instances, system 200 determines the LAT, LONG of the center of an area represented by the FSA instead of the LAT, LONG coordinates of a building's location.

Referring again to service region Nova Scotia 500d in FIG. 5B, shown are weather stations 504, 506 and 508 located in Amherst, Debert, and Kentville, respectively, located in a same general area of home 502.

Next, system 200 determines the weather station closest to home 502. LAT, LONG coordinates of weather stations 504, 506 and 508 are (45.76, −64.24), (45.42, −63.57) and (45.07, −64.48), respectively.

System 200 determines weather station 506 located in Debert is closest to home 502. As such, system 200 receives historical weather data (e.g., annual daily temperature) recorded by the Debert weather station from remote server 212. For example, remote server 212 hosts an Environment Canada server stores weather data from weather stations which is publicly accessible. A specific and non-limiting example of historical weather data includes 10 years of hourly temperature recorded by a weather station. System 200 may store historical weather data, for example, in datastore 204.

Next, system 200 calculates average annual heating degree days based on the historical weather data received. For example, system 200 uses a base temperature 18 C and determines an average number of annual heating degree days is 199, and stores average annual heating degree days data, for example, in datastore 204.

System 200 receives historical weather data corresponding to each of the other 1999 homes and determines average annual heating degree days for each thereof in a same manner as described above and stores average annual heating degree days data, for example, in datastore 204.

Next, at block 306 process 300 includes forming training data based on at least a portion of building-related data.

In the present example, system 200 forms training data including a portion of building energy assessment software assessment data, in particular, input data IN1-IN7 shown in table 600 and building energy assessment software output data, total home energy consumption data. Training data may be stored, for example, in datastore 204.

Next, at block 308, process 300 includes training a machine learning algorithm to create a building energy analysis model.

For example, system 200 trains a machine learning algorithm with training data to create a model for predicting total home energy consumption of a building, model THEC_04.

When used for predicting total home energy consumption of a building corresponding to service region Nova Scotia, input data IN1-IN7 is processed by model THEC_04.

Process 300 returns to block 306.

At block 306 process 300 includes forming training data based on at least a portion of energy assessment data.

In the present example, system 200 forms training data including a portion of building energy assessment software assessment data, input data IN1-IN9 shown in table 600 and building energy assessment software output data, total home energy consumption data. Training data may be stored, for example, in datastore 204.

Next, at block 308, process 300 includes training a machine learning algorithm to create a building energy analysis model.

For example, system 200 trains a machine learning algorithm with training data to create a model for predicting total home energy consumption of a building, model THEC_05.

When used for predicting total home energy consumption of a building corresponding to service region Nova Scotia, input data IN1-IN9 is processed by model THEC_05.

Process 300 returns to block 306.

At block 306 process 300 includes forming training data based on at least a portion of energy assessment data.

In the present example, system 200 forms training data including a portion of building energy assessment software assessment data, in particular, input data IN1-IN9, and IN24, 10-year average annual heating degree days (if available), shown in table 600 and building energy assessment software output data, total home energy consumption data. Training data may be stored, for example, in datastore 204.

Next, at block 308, process 300 includes training a machine learning algorithm to create a building energy analysis model.

For example, system 200 trains a machine learning algorithm with training data to create a model for predicting total home energy consumption of a building, model THEC_06.

When used for predicting total home energy consumption of a building corresponding to service region Nova Scotia, input data IN1-IN24 is processed by model THEC_06.

Modelling techniques used for training a machine learning algorithm to create a building energy analysis model may include statistical and/or machine learning techniques such as regression analysis, decision trees, neural networks, support vector machines, nearest neighbors, ensemble methods, or any other suitable technique.

Next, at block 310, process 300 includes scoring the plurality of building energy analysis models.

For example, system 200 evaluates the accuracy of plurality of models THEC_04, THEC_05 and THEC_06. In this example, model THEC_04 is the least accurate model, model THEC_05 is the next most accurate model relative to model THEC_04, and THEC_06 is the most accurate model. System 200 then assigns a score of 10, 20 and 30 to models THEC_04, THEC_05 and THEC_06, respectively.

Alternatively, each of the plurality of models are scored based on data sensitivity. Further alternatively, each of the plurality of models are scored based on execution runtime. Further alternatively, each of the plurality of models are scored based on another model metric. Further alternatively, a score of a model is based on a combination of model metrics.

Next, at block 312, process 300 includes storing an indication of each of the plurality of models in association with corresponding service region, score, and input criteria.

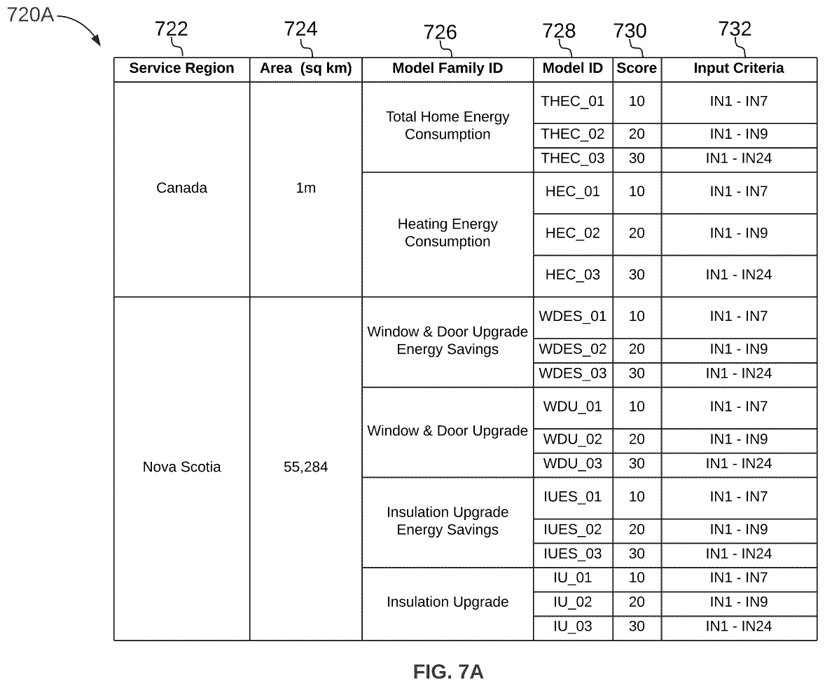

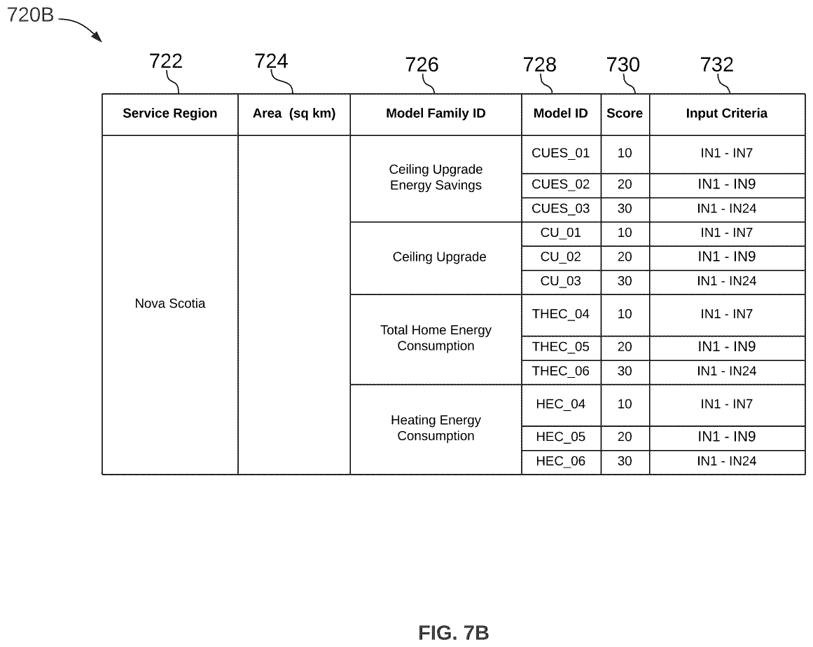

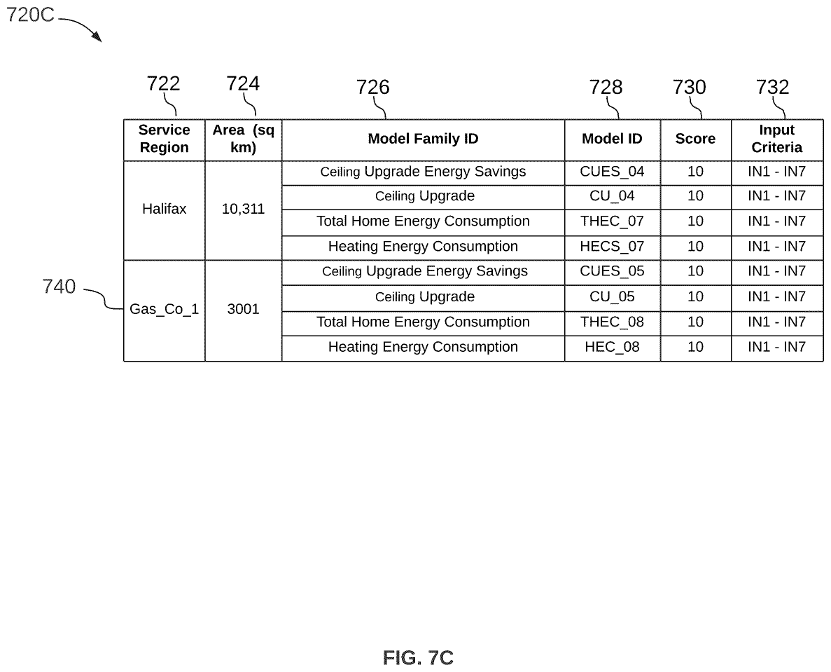

For example, system 200 stores an indication of the plurality of models THEC_04, THEC_05 and THEC_06, in association with service region Nova Scotia, scores 10, 20 and 30 respectively, input criteria, IN1-IN7, IN1-IN9 and IN1-IN23, respectively, as shown in table 720B in FIG. 7B.

In the exemplary process for creating a plurality of building energy analysis models described above, process 300 creates models that emulates one of the energy characteristics predicted by building energy assessment software, Total Home Energy Consumption of a building. Numerous other energy characteristics predicted by building energy assessment software will be apparent to persons skilled in the art.

Furthermore, in the exemplary process 300 described above, multiple models were created based on subsets of input data the inventor expected to be available. In a first example, IN1-IN7 used for creating model THEC_04 may be available in publicly accessible information, such tax assessment data. In a second example, IN1-IN9 used for creating model THEC_05 may be data a homeowner could easily provide. In a third example, IN1-IN23 used for creating model THEC_06 may be data an energy advisor could provide.

For descriptive purposes, exemplary process 300 described above uses a machine learning technique. In practise, however, methods other than using a machine learning technique are implemented for creating a plurality of building energy analysis models. A specific and non-limited example includes a method for creating a plurality of building energy analysis models in the form of mathematical/physics models.

### Network Configuration 801

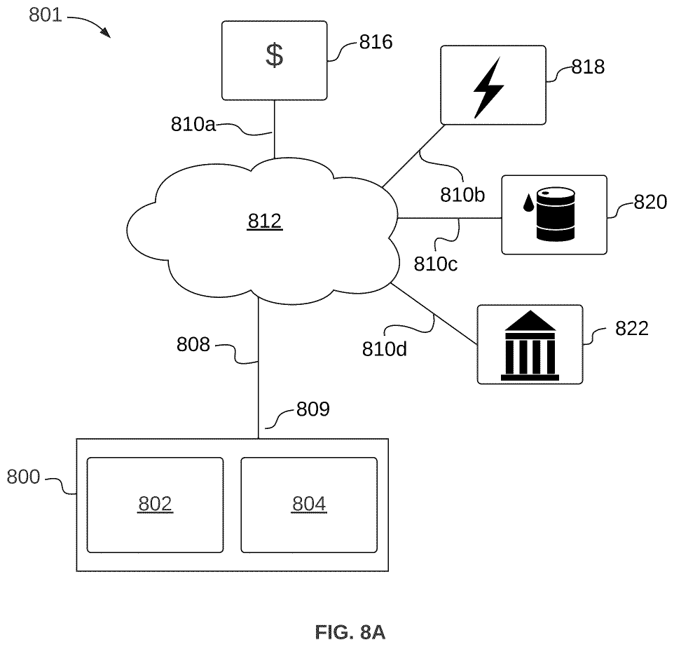

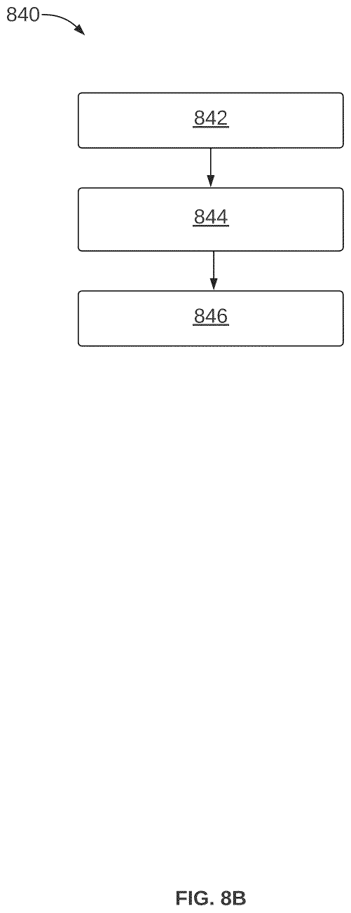

Illustrated in FIG. 8A is a simplified diagram of an exemplary network configuration 801 within which some embodiments may operate. Network configuration 801 includes system 800, remote servers 816, 818, 820, 822 and communication network 812. Communication network 812 may be communicatively coupled to system 800 and remote servers 816, 818, 820, and 822, enabling communication therebetween. For example, system 800 may be communicatively coupled to communication network 812 via communication link 808. Remote servers 816, 818, 820, 822, may be communicatively coupled to communication network 812 via communication link 808 and 810, as shown.

Communication network 812 may include one or more computing systems and may be any suitable combination of networks or portions thereof to facilitate communication between network components. Some examples of networks include, Wide Area Networks (WANs), Local Area Networks (LANs), Wireless Wide Area Networks (WWANs), data networks, cellular networks, voice networks, among other networks, which may be wired and/or wireless. Communication network 812 may operate according to one or more communication protocols, such as, General Packet Radio Service (GPRS), Universal Mobile Telecommunications Service (UMTS), GSM, Enhanced Data Rates for GSM Evolution (EDGE), LTE, CDMA, LPWAN, Wi-Fi, Bluetooth, Ethernet, HTTP/S, TCP, and CoAP/DTLS, or other suitable protocol. Communication network 812 may take other forms as well.

System 800 includes processing resource 802, datastore 804, and network interface 809.

### Process 840

According to an embodiment, there is a method for at least predicting energy-related metric of a building using a machine learning technique.

Shown in FIG. 8B is a simplified flow diagram of an exemplary process 840 for predicting an energy-related metric of a building. Predicting an energy-related metric of a building includes at least one of recommending a building upgrade and predicting an energy characteristic of a building.

Process 840 is described as carried out by system 800 shown in FIG. 8A. Alternatively, process 840 may be carried out by another system, a combination of other systems, subsystems, devices or other suitable means provided the operations described herein are performed. Process 840 may be automated, semi-automated and some blocks thereof may be manually performed.

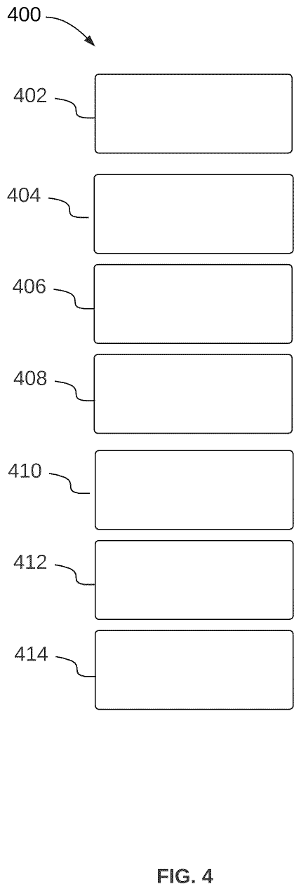

Process 840 is described below with reference to FIG. 4, FIG. 5A, FIG. 5B, FIG. 5C, FIG. 6, FIG. 7A, FIG. 7B, FIG. 7C, FIG. 8A, and FIG. 8B.

Starting at block 842 process 840 includes selecting a first model including, selecting a first service region corresponding to a building, selecting a second subset of models corresponding to the first service region based on building-related data corresponding to a building, and selecting the first model from the second subset of models based on a score of the first model.

For example, selecting a first service region corresponding to the building includes processing boundary data for a first plurality of service regions and selecting a second plurality of service regions therefrom based on the second plurality of service regions corresponding to the building location. Selecting the first service corresponding to the building further includes selecting the first service region from the second plurality of service regions based on a size thereof.

An exemplary first plurality of service regions includes Canada 500, British Columbia 501a, Ontario 501b, New Brunswick 501c, Nova Scotia 501d, shown in FIG. 5A and Halifax 512 and Gas_C0_1 516 shown in FIG. 5C.

Shown in FIG. 4 is a visual representation of boundary data 400 corresponding to the first plurality of service regions. In this example, boundary data 400, includes a plurality of service region boundary files in GeoJSON format including Canada.GeoJSON 402, British Columbia.GeoJSON 404, Ontario.GeoJSON 406, New Brunswick.GeoJSON 408, Nova Scotia.GeoJSON 410, Halifax.GeoJSON 412 and Gas_Co_1. GeoJSON 414, corresponding to service regions Canada 500, British Columbia 501a, Ontario 501b, New Brunswick 501c, Nova Scotia 501d, as shown in FIG. 5A, Halifax 512 and Gas_Co_1 516, shown in FIG. 5C. System 800 stores exemplary boundary data 400, for example, in datastore 804.

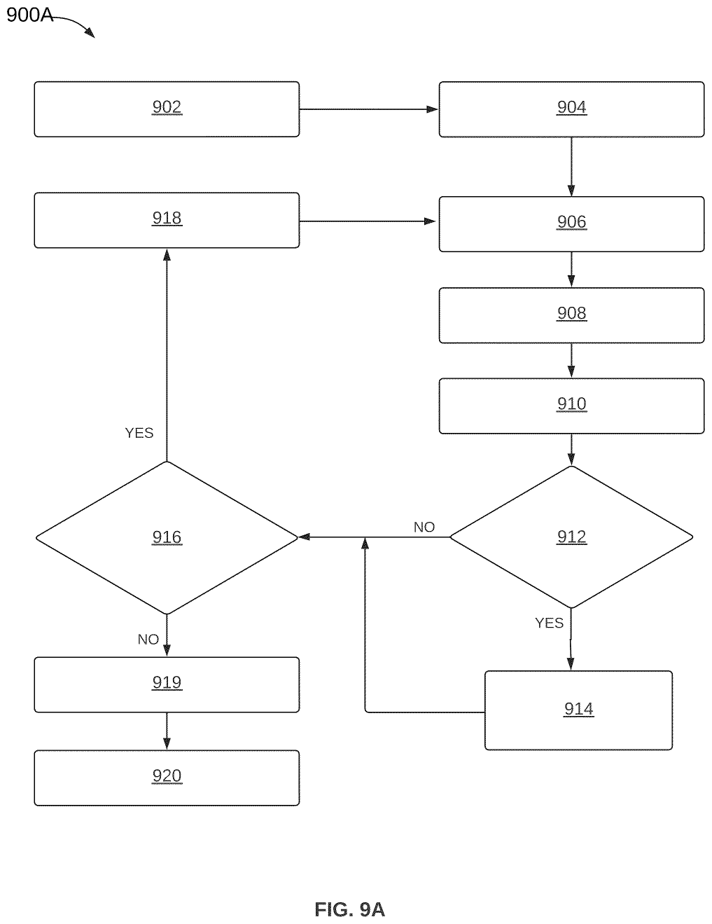

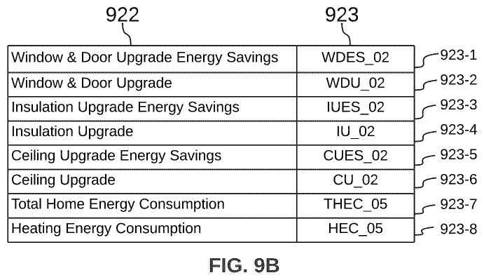

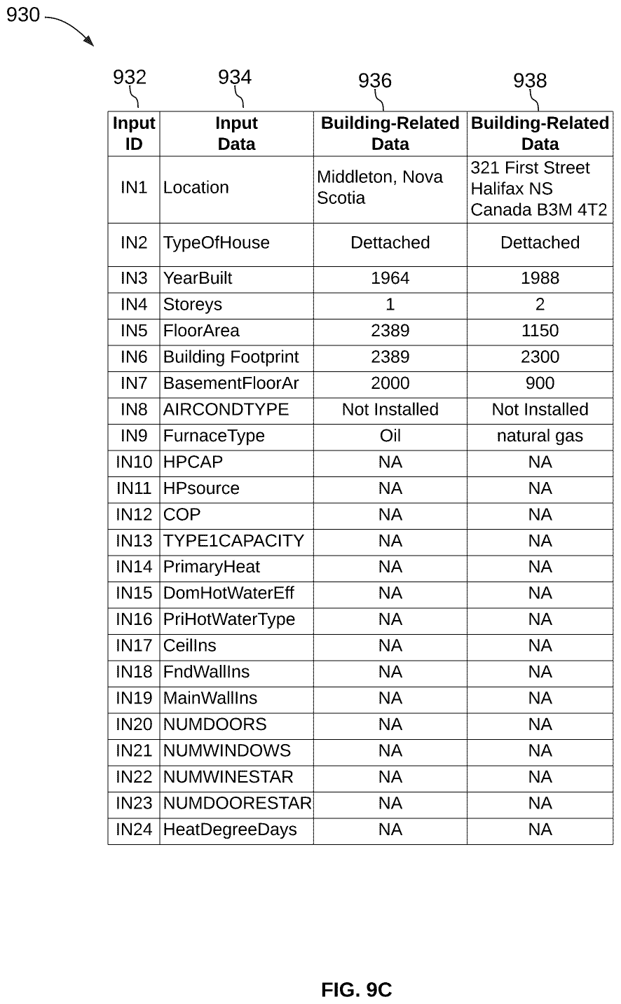

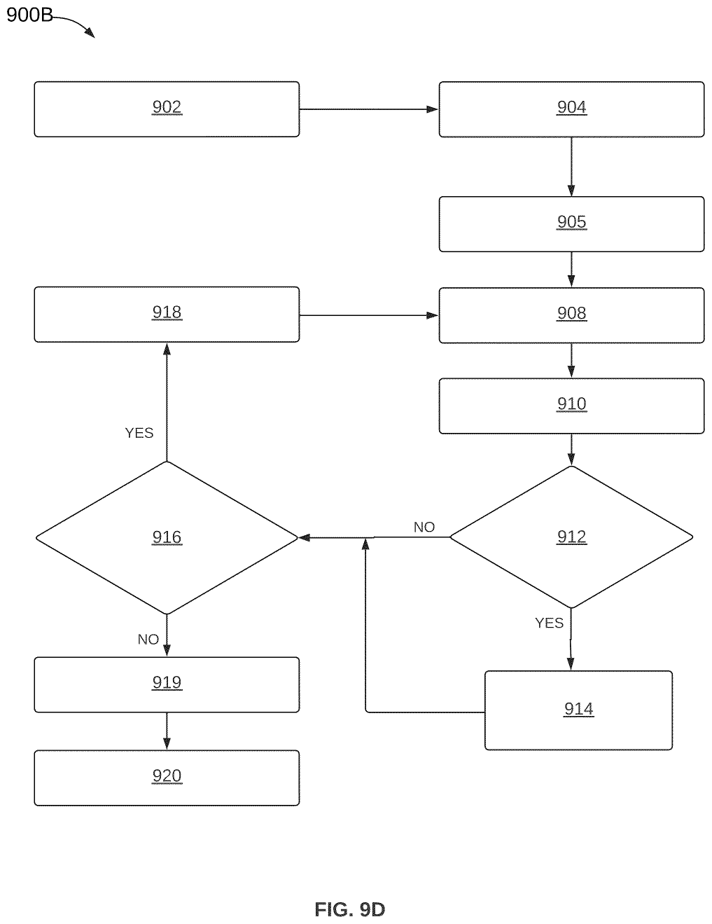

Shown in FIG. 9C is exemplary building-related data 936 corresponding to building 511 shown in FIG. 5B. System 800 selects a second plurality of service regions from the first plurality of service regions corresponding to building 511 shown in FIG. 5B.

For example, system 800 processes exemplary building-related data 936 corresponding to building 511 for converting the address of building 511 into LAT, LONG coordinates. For instance, system 800 transmits data indicating the address of the building 511 to a geocoding service based in the cloud and receives from the geocoding service data indicating LAT. LONG coordinates of building 511 to be (44.941429, −65.076851) and creates coordinate data indicative thereof. Exemplary geocoding services include Geocoding API® (from Google® web services), Mapbox® Geocoding API, and Amazon® Location Service®.

Next, system 800 processes boundary data 400 and coordinate data indicating coordinates (44.941429, −65.076851) of building 511 for selecting a second plurality of service regions from the first plurality of service regions. System 800 determines building 511 corresponds to a second plurality of service regions including service regions Nova Scotia 501d and Canada 500.

Next system 800 selects the first service region by selecting the smallest service region of the plurality of second service regions.

For example, system 800 processes area data 724 corresponding to the second plurality of service regions, Nova Scotia 501d and Canada 500. In this example, area data 724 corresponding to service region Nova Scotia 501d indicates an area of 55,284 sq km and area data 724 corresponding to service region Canada 500 indicates an area of 1 m sq km. The area of service region Nova Scotia 501d is smaller than the service region Canada 500. As such, system 800 determines service region Nova Scotia 501d is the first service region.

Referring now to tables 720A and 720B in FIG. 7A and FIG. 7B, respectively, shown are a plurality of model families 726 corresponding to the first service region Nova Scotia 501d, including. Window & Door Upgrade Energy Savings, Window & Door Upgrade, Insulation Upgrade Energy Savings, Insulation Upgrade, Ceiling Upgrade Energy Savings, Ceiling Upgrade, Total Home Energy Consumption and Heating Energy Consumption.

A model family includes one or more models for predicting a same energy-related metric of a building. A model family may have one or more subsets of models associated with one or more service regions. For instance, model family Total Home Energy Consumption includes a subset of models including THEC_01, THEC_02, and THEC_02 associated with service region Canada 500, a subset of models including THEC_03, THEC_04, and THEC_05 associated with service region Nova Scotia 501d, a subset of models, THEC_07, associated with service region Halifax 512, and a subset of models, THEC_08, associated with service region Gas_Co_1 516.

Referring again to first service region Nova Scotia 501d a first subset of models of model family Window & Door Upgrade Energy Savings corresponding to the first service region Nova Scotia 501d includes WDES_01, WDES_02 and WDES_03, as shown in FIG. 7A. The first subset of models WDES_01, WDES_02 and WDES_03, have corresponding input criteria including (IN1-IN7), (IN1-IN9), and (IN1-IN24), respectively.

Next, system 800 selects a subset of models corresponding to the first service region based on building-related data corresponding to the building.

For example, building-related data 936 corresponding to building 511 to includes IN1-IN9. Building-related data 936 meets input criteria of models WDES_01 and WDES_02 only. For model family Window & Door Upgrade Energy Savings, system 800 forms a second subset of models corresponding to model family Window & Door Upgrade Energy Savings including model WDES_01 and model WDES_02.

Next, system 800 selects the first model from the second subset of models based on a score of the first model.

In the present example, the second subset of models corresponding to model family Window & Door Upgrade Energy Savings, model WDES_01 and model WDES_02, have model scores 10 and 20 respectively. Model WDES_01 has a greater model score, 20, compared to a model score, 10, of model WDES_02. As such, system 800 selects model WDES_02 as the first model corresponding to model family Window & Door Upgrade Energy Savings.

Next, at block 844, process 840 includes processing building-related data by the first model for predicting the energy-related metric of the building.

In a first example, system 800 processes building-related data 936 using first model WDES_02 corresponding to model family Window & Door Upgrade Energy Savings for recommending a window and door upgrade.

Finally, at block 846, process 840 includes providing indication data indicative of the energy-related metric of the building.

In a first example, system 800 creates indication data indicating the window and door upgrade energy savings and stores the indication data, for example, for future use.

Alternatively, system 800 transmits the indication data to a server accessible to a building owner. Further alternatively, system 800 provides the indication data via email, and/or text, and/or another electronic communication means.

For example, system 800 transmits indication data to a server accessible by an owner of building 511. In some instance, system 800 may send indication data to an owner of a building in an email and/or text and/or by another electronic communication means.

Alternatively, an owner of a building logs into system 800 to retrieve the indication data. Further alternatively, system 800 transmits indication data to another system which an owner of a building logs into to retrieve indication data.

### Process 900A

According to an embodiment, there is a method for predicting an energy-related metric of a building. Predicting an energy-related metric of a building includes at least one of recommending a building upgrade and predicting an energy characteristic of a building.

Shown in FIG. 9A is simplified flow diagram of process 900A for predicting an energy-related metric of a building.

Process 900A is described as carried out by system 800 operating in network environment 801 shown in FIG. 8, described hereinabove. Process 900A is described below with reference to FIG. 4, FIG. 5A, FIG. 5C, FIG. 6, FIG. 7A, FIG. 7B, FIG. 7C, FIG. 8A, FIG. 9A, FIG. 9B, and FIG. 9C. [9D]

Starting at block 902, process 900A includes processing building-related data corresponding to a building and boundary data corresponding to a first plurality of service regions for selecting a second plurality of service regions, the second plurality of service regions corresponding to the building.

For example, shown in FIG. 9C is exemplary building-related data 938 corresponding to building 518, in the form of a residential home, shown in FIG. 5C.

A diagrammatic view of exemplary boundary data 400 is shown in FIG. 4. Boundary data 400 corresponds to a first plurality of service regions including Canada 500, British Columbia 501a, Ontario 501b, New Brunswick 501c, Nova Scotia 501d shown in FIG. 5A, and Halifax 512 and Gas_Co_1 516 shown in FIG. 5C.

In the present example, building-related data 938 indicates that the home 518 is located on 321 First Street, Halifax, NS, Canada, B3M 4T2. System 800 converts the address of building 518 into LAT, LONG coordinates. For instance, system 800 transmits data indicating the address of the first home to a geocoding service based in the cloud and receives from the geocoding service data indicating coordinates of the first home to be (44.664689, −63.652102). System 800 creates Lat_Long1 data indicating LAT, LONG coordinates (44.664689, −63.652102).

Next system 800 processes Lat_Long1 data and boundary data 400 for identifying one or more services regions within which the building 518 is located. System 800 processes Lat_Long1 data and service region boundary files Canada.GeoJSON 402, British Columbia.GeoJSON 404, Ontario.GeoJSON 406, New Brunswick.GeoJSON 408, Nova Scotia. GeoJSON 410, Halifax.GeoJSON 412 and Gas_Co_1. GeoJSON 414, corresponding to service regions Canada 500, British Columbia 501a, Ontario 501b, New Brunswick 501c, Nova Scotia 501d, as shown in FIG. 5A, Halifax 512 and Gas_Co_1 516 shown in FIG. 5C, using, for example, a polygon function.

System 800 determines that building 518 is located within the following service regions, Canada 500, Nova Scotia 501d, Halifax 512 and Gas_Co_1 516.

System 800 selects service regions Canada 500, Nova Scotia 501d, Halifax 512 and Gas_Co_1 516 for forming a second plurality of service regions corresponding to building 518. System 800 also creates service region data indicative of service regions, Canada 500, Nova Scotia 501d, Halifax 512 and Gas_Co_1 516, and stores it, for example, in datastore 804.

Next at block 904, process 900A incudes selecting a present service region from the second plurality of service regions based on the present service region having an area smaller in size in comparison to an area of other service regions of the second plurality of service regions.

Exemplary service region data is shown in table 720 of FIG. 7A, FIG. 7B, and FIG. 7C, including service region ID data 722, indicating a unique ID for each of the second plurality of service regions and area data 724 indicating a size of the area of the corresponding service region in square kilometers.

Table 720 also includes exemplary Model Family ID data 726 indicating a unique ID for a model family corresponding to a service region. A model family corresponding to a service region includes a subset of models corresponding to the service region. Model ID data 728 indicates a unique ID for each model of a subset of models corresponding to the service region. Table 720 also includes score data 730 indicative of a score of a corresponding model as well as input criteria data 732 indicating required input data for employing a corresponding model. Exemplary input data is shown in table 600 of FIG. 6.

A model family may have subsets of models corresponding to one or more service regions. For example, model family Total Home Energy Consumption has a subset of models THEC_01, THEC_02 and THEC_03 corresponding service region Canada 500. Model family Total Home Energy Consumption also has a subset of models, THEC_04, THEC_05 and THEC_06 corresponding to service region Nova Scotia 501d, a subset of models, THEC_07 corresponding to service region Halifax 512, and a subset of models THEC_08 corresponding to service region Gas_Co_1 516.

System 800 processes area data 724 corresponding to the second plurality of service regions, Canada 500, Nova Scotia 501d, Halifax 512 and Gas_Co_1 516, having areas 1 m sq km, 55,284 sq km, 10,311 sq km, and 3001 sq km, respectively, as shown. In this example, service region Gas_Co_1 516 has the smallest area size, 3001 sq km of all of the second plurality of service regions. System 800 selects service region Gas_Co_1 516 as the present service region. System 800 creates present service region data to indicate service region Gas_Co_1 516.

Next, at block 906, process 900, includes, for each model family of a plurality of model families including a first subset of models corresponding to the present service region and provided final model data indicative of a final model does not exist, creating final model data for the model family. Final model data includes final model ID data indicative of a model ID of the final model and final model score data indicative of a score of the final model, and both final model ID data and final model score data having a value of 0′.

In the present example, the plurality of model families associated with the second plurality of service regions Canada 500, Nova Scotia 501d, Halifax 512 and Gas_Co_1 516, includes, Window & Door Upgrade Energy Savings′, Window & Door Upgrade′, Insulation Upgrade Energy Savings′, Insulation Upgrade′, Ceiling Upgrade Energy Savings′, Ceiling Upgrade, Total Home Energy Consumption and Heating Energy Consumption′, shown in table 720.

However, only model families Ceiling Upgrade Energy Savings′, Ceiling Upgrade, Total Home Energy Consumption and Heating Energy Consumption have a first subset of models, including, CUES_01, CU_01, THEC_08 and HEC_08, respectively, corresponding to the present service region, Gas_Co_1 516. As no final model data has yet been created for model families Ceiling Upgrade Energy Savings′, Ceiling Upgrade, Total Home Energy Consumption and Heating Energy Consumption′, system 800 creates final model data for each thereof, including final model ID data and final model score data each having a value of 0′. Table 2 indicates the present value of model data for model families Ceiling Upgrade Energy Savings′, Ceiling Upgrade, Total Home Energy Consumption and Heating Energy Consumption′.

TABLE 2

| | Final | Final |
|---|---|---|
| | Model ID | Model Score |
| Ceiling Upgrade Energy Savings Final Model | 0 | 0 |
| Ceiling Upgrade Final Model | 0 | 0 |
| Total Home Energy Consumption Final Model | 0 | 0 |
| Heating Energy Consumption Final Model | 0 | 0 |

Next, at block 908, process 900A includes for each model family of a plurality of model families including a first subset of models corresponding to the present service region, selecting a second subset of models therefrom based on corresponding building-related data meeting input criteria of each thereof.

In a first example, model family Ceiling Upgrade Energy Savings includes a first subset of models corresponding to the present region Gas_Co_1. Model family Ceiling Upgrade Energy Savings has a first subset of models including only one model, CUES_05, having input criteria of IN1-IN7. Building-related data 938 includes IN1-IN9, as shown in FIG. 9C, which includes IN1-IN7 and thus meets input criteria of model CUES_05. As such, system 800 selects, for model family Ceiling Upgrade Energy Savings′, a second subset of models including model CUES_05 only.

In a second example, a model family Ceiling Upgrade includes a first subset of models corresponding to the present region Gas_Co_1. Model family Ceiling Upgrade has a first subset of models including only one model, CU_05, having input criteria of IN1-IN7. Building-related data 938 includes IN1-IN9, as shown in FIG. 9C, which includes IN1-IN7 and thus meets input criteria of model CU_05. As such, system 800 selects, for model family Ceiling Upgrade′, a second subset of models including model CU_05 only.

In a third example, a model family Total Home Energy Consumption includes a subset of models corresponding to the present region Gas_Co_1. Model family Total Home Energy Consumption has a first subset of models including only one model, THEC_08, having input criteria of IN1-IN7. Building-related data 938 includes IN1-IN9 as shown in FIG. 9C, which includes IN1-IN7 and thus meets input criteria of model THEC_08. As such, system 800 selects, for model family Total Home Energy Consumption′, a second subset of models including model THEC_08 only.

In a fourth example, a model family Heating Energy Consumption includes a first subset of models corresponding to the present region Gas_Co_1. Model family Heating Energy Consumption has a first subset of models including only one model, HEC_08, having input criteria of IN1-IN7. Building-related data 938 includes IN1-IN9 as shown in FIG. 9C, which includes IN1-IN7 and thus meets input criteria of model HEC_08. As such, system 800 selects, for model family Heating Energy Consumption′, a second subset of models including model HEC_08 only.

Next, at block 910, process 900A includes for each model family of a plurality of model families corresponding to the present service region, selecting a first model from the second subset of models based on a model score of the first model having a greater value compared to a model score of other models of the second subset of models.

In a first example, for model family Ceiling Upgrade Energy Savings the second subset of models only includes one model, CUES_05, having a score 10. There are no other model scores to compare to the score of model CUES_05. As such system 800 selects model CUES_05 as the first model for model family Ceiling Upgrade Energy Savings′.

System 800 processes the second subset of models for each of the other model families Ceiling Upgrade′, Total Home Energy Consumption′, and Heating Energy Consumption for selecting a corresponding first model. For similar reasoning as described above with respect to model family Ceiling Upgrade Energy Savings′, system 800 selects models CU_05, THEC_08, and HEC_08, each having a score of 10, for model families Ceiling Upgrade′, Total Home Energy Consumption′, and Heating Energy Consumption′, respectively.

Next, at block 912, process 900A includes, for each model family of a plurality of model families corresponding to the present service region, determining if the model score of the first model exceeds final score model data. If the model score of the first model exceeds the final model score, process 900A proceeds to block 914, otherwise it proceeds to block 916.

For example, for model family Total Home Energy Consumption the final model score is 0 and the model score of the first model THEC_08 is 10. As such, the model score of the first model THEC_08 exceeds the final model score 0, process 900A proceeds to block 914.

For model families Ceiling Upgrade′, Total Home Energy Consumption′, and Heating Energy Consumption each corresponding final model score is 0 and the model score of each corresponding first model is 10. As such, for each family, the model score of the first model exceeds the final model score, and process 900A also proceeds to block 914.

Next, at block 914, process 900A includes for each model family of a plurality of model families corresponding to the present service region, modifying corresponding final model data including modifying final model ID data to be same as first model ID data and final model score data to be same as score data of the first model score data.

For example, the final model data corresponding to model family Ceiling Upgrade Energy Savings includes modifying Final Model ID data to indicate a same model ID as the first model CUES_05 and modifying Final Model Score data to indicate a same model score 10 as the first model CUES_05.

In another example, final model data corresponding to model family Ceiling Upgrade includes modifying Final Model ID data to indicate a same model ID as the first model CU_05 and modifying Final Model Score data to indicate a same model score 10 as the first model CU_05.

In yet another example, final model data corresponding to model family Total Home Energy Consumption includes modifying Final Model ID data to indicate a same model ID as the first model THEC_08 and modifying Final Model Score data to indicate a same model score 10 as the first model THEC_08.

In a final example, the final model data corresponding to model family Heating Energy Consumption includes modifying Final Model ID data to indicate a same model ID as the first model HEC_08 and modifying Final Model Score data to indicate a same model score 10 as the first model HEC_08.

Table 3 indicates the present value of final model data including final model ID data and final model score data for model families Ceiling Upgrade Energy Savings′, Ceiling Upgrade, Total Home Energy Consumption and Heating Energy Consumption′.

TABLE 3

| | Final | Final |
|---|---|---|
| | Model ID | Model Score |
| Ceiling Upgrade Energy Savings Final Model | CUES_05 | 10 |
| Ceiling Upgrade Final Model | CU_05 | 10 |
| Total Home Energy Consumption Final Model | THEC_08 | 10 |
| Heating Energy Consumption Final Model | HEC_08 | 10 |

Next, at block 916, process 900A includes determining whether a next service region of the second plurality of service regions has an area subsequently larger in size in comparison to an area of the present service region. If so, process 900A proceeds to block 918, otherwise it proceeds to block 919.

For example, system 800 processes area data 724 corresponding to other service regions of second plurality of service regions, including Canada 500, Nova Scotia 501d, and Halifax 512 having areas 1 m sq km, 55,284 sq km, and 10,311 sq km, respectively, as shown in column 724 of table 720. In this example, service region Halifax 512 has an area 10,311 sq km which is the next subsequently larger service region in size (i.e., area) compared to the area 3001 sq km of present service region Gas_C0_1 516. As such, process 900A proceeds to block 918. System 800 selects service region Halifax 512 as the next service region.

At block 918, process 900A includes modifying present service region data to be same as next service region data and repeats blocks 906 to 912.

For example, system 800 modifies present service region data to indicate the next service region, Halifax 512. Process 900A then proceeds to block 906

At block 906, process 900, includes, for each model family of a plurality of model families including a first subset of models corresponding to the present service region, provided final model data indicative of a final model other than exists, creating final model data for the model family. Final model data includes final model ID data indicative of a model ID of the final model and final model score data indicative of a score of the final model, and both final model ID data and final model score data have a value of 0′.

Model families Ceiling Upgrade Energy Savings′, Ceiling Upgrade, Total Home Energy Consumption and Heating Energy Consumption have a first subset of models, including, CUES_04, CU_04, THEC_07 and HEC_07, respectively, corresponding to the present service region, Halifax 512, as shown in table 720, FIG. 7C. As final model data has already been created for model families Ceiling Upgrade Energy Savings′, Ceiling Upgrade, Total Home Energy Consumption and Heating Energy Consumption′, system 800 proceeds to block 908.

Next, at block 908, process 900A includes for each model family of a plurality of model families including a first subset of models corresponding to the present service region, selecting a second subset of models therefrom based on the building-related data meeting input criteria of each thereof.

In a first example, model family Ceiling Upgrade Energy Savings includes a first subset of models corresponding to the present region Halifax 512. Model family Ceiling Upgrade Energy Savings has a first subset of models including only one model, CUES_04, having input criteria of IN1-IN7. Building-related data 938 includes IN1-IN9 as shown in FIG. 9C, which includes IN1-IN7 and thus meets input criteria of model CUES_04. As such, system 800 selects, for model family Ceiling Upgrade Energy Savings′, a second subset of models including CUES_04 only.

In a second example, model family Ceiling Upgrade includes a first subset of models corresponding to the present region Halifax 512. Model family Ceiling Upgrade has a first subset of models including only one model, CU_04, having input criteria of IN1-IN7. Building-related data 938 includes IN1-IN9 as shown in FIG. 9C, which includes IN1-IN7 and thus meets input criteria of model CU_04. As such, system 800 selects, for model family Ceiling Upgrade′, a second subset of models including CU_04 only.

In a third example, a model family Total Home Energy Consumption includes a first subset of models corresponding to the present region Halifax 512. Model family Total Home Energy Consumption has a first subset of models including only one model, THEC_07, having input criteria of IN1-IN7. Building-related data 938 includes IN1-IN9 as shown in FIG. 9C, which includes IN1-IN7 and thus meets input criteria of model THEC_07. As such, system 800 selects, for model family Total Home Energy Consumption′, a second subset of models including THEC_07 only.

In a fourth example, a model family Heating Energy Consumption includes a first subset of models corresponding to the present region Halifax 512. Model family Heating Energy Consumption has a first subset of models including only one model, HEC_07, having input criteria of IN1-IN7. Building-related data 938 includes IN1-IN9 as shown in FIG. 9C, which includes IN1-IN7 and thus meets input criteria of model HEC_07. As such, system 800 selects, for model family Heating Energy Consumption′, a second subset of models including HEC_07 only.

Next, at block 910, process 900A includes for each model family of a plurality of model families corresponding to the present service region, selecting a first model from the second subset of models based on a model score of the first model having a greater value compared to a model score of other models of the second subset of models.

In a first example, for model family Ceiling Upgrade Energy Savings the second subset of models only includes one model, CUES_04, having a score 10. There are no other model scores to compare to the score of model CUES_04. As such system 800 selects model CUES_04 as the first model for model family Ceiling Upgrade Energy Savings′.

System 800 processes the second subset of models for each of the other model families Ceiling Upgrade′, Total Home Energy Consumption′, and Heating Energy Consumption for selecting a corresponding first model. For similar reasoning as described above with respect to model family Ceiling Upgrade Energy Savings′, system 800 selects models U_04, THEC_07, and HEC_07, each having a score of 10, as the first model for model families Ceiling Upgrade′, Total Home Energy Consumption′, and Heating Energy Consumption′, respectively.

Next, at block 912, process 900A includes, for each model family of a plurality of model families corresponding to the present service region, determining if the model score of the first model exceeds final score model data. If the model score of the first model exceeds the final model score, process 900A proceeds to block 914, otherwise it proceeds to block 916.

For example, for model family Total Home Energy Consumption the final model score is 10 and the model score of the first model is 10. As such, the model score of the first model does not exceed the final model score, process 900A proceeds to block 916.

For model families Ceiling Upgrade′, Total Home Energy Consumption′, and Heating Energy Consumption each corresponding final model score is 10 and the model score of each corresponding first model is 10. As such, for each family, the model score of the first model does not exceed the final model score, and process 900A proceeds to block 916.

Next, at block 916, process 900A includes determining whether a next service region of the second plurality of service regions has an area subsequently larger in size in comparison to an area of the present service region. If so, process 900A proceeds to block 918, otherwise it proceeds to block 919.

For example, system 800 processes area data 724 corresponding to other service regions of second plurality of service regions, including Canada 500 and Nova Scotia 501d having areas 1 m sq km and 55,284 sq km, respectively, as shown in column 724 of table 720. In this example, service region Nova Scotia 501d has an area 55,284 sq km which is the next subsequently larger service region in size (i.e., area) compared to the area 10,311 sq km of present service region Halifax 512. As such, process 900A proceeds to block 918. System 800 selects service region Nova Scotia 501d as the next service region.

At block 918, process 900A includes modifying present service region data to be same as next service region data and repeats blocks 906 to 916.

For example, system 800 modifies present service region data to indicate the next service region, Nova Scotia 501d. Process 900A proceeds to block 906

At block 906, process 900, includes, for each model family of a plurality of model families including a first subset of models corresponding to the present service region, provided final model data indicative of a final model other than exists, creating final model data for the model family. Final model data includes final model ID data indicative of a model ID of the final model and final model score data indicative of a score of the final model, and both final model ID data and final model score data have a value of 0′.

In the present example, there are eight model families associated with service region Nova Scotia, including Window & Door Upgrade Energy Savings, Window & Door Upgrade, Insulation Upgrade Energy Savings, Insulation Upgrade, Ceiling Upgrade Energy Savings, Ceiling Upgrade, Total Home Energy Consumption and Heating Energy Consumption. Final model family data for Ceiling Upgrade Energy Savings, Ceiling Upgrade, Total Home Energy Consumption and Heating Energy Consumption exists, as shown in Table 3.

However, model family data for Window & Door Upgrade Energy Savings, Window & Door Upgrade, Insulation Upgrade Energy Savings, Insulation Upgrade families do not exist. As such, system 800 creates model family data for model families Window & Door Upgrade Energy Savings, Window & Door Upgrade, Insulation Upgrade Energy Savings, Insulation Upgrade. System 800 creates final model data for each thereof, including final model ID data and final model score data each having a value of 0′.

Table 4 indicates the present value of model data for model families Window & Door Upgrade Energy Savings′, Window & Door Upgrade, Insulation Upgrade Energy Savings and Insulation Upgrade′.

TABLE 4

| | Final | Final |
|---|---|---|
| Model Family | Model ID | Model Score |
| Window & Door Upgrade Energy Savings | 0 | 0 |
| Window & Door Upgrade | 0 | 0 |
| Insulation Upgrade Energy Savings | 0 | 0 |
| Insulation Upgrade | 0 | 0 |

Next, at block 908, process 900A includes for each model family of a plurality of model families including a first subset of models corresponding to the present service region, selecting a second subset of models therefrom based on the building-related data meeting input criteria of each thereof.

In a first example, model family Window & Door Upgrade Energy Savings includes a first subset of models corresponding to the present region Nova Scotia 501d. Model family Window & Door Upgrade Energy Savings has a first subset of models including models, WDES_01, WDES_02 and WDES_03 having input criteria of IN1-IN7, IN1-IN9, and IN1-IN24, respectively. Building-related data 938 includes IN1-IN9 as shown in FIG. 9C, which meets input criteria of models WDES_01 and WDES_02. As such, system 800 selects, for model family Window & Door Upgrade Energy Savings′, a second subset of models including WDES_01 and WDES_02.

In a second example, model family Window & Door Upgrade includes a first subset of models corresponding to the present region Nova Scotia 501d. Model family Window & Door Upgrade has a first subset of models including models, WDU_01, WDU_02 and WDU_03 having input criteria of IN1-IN7, IN1-IN9, and IN1-IN24, respectively. Building-related data 938 includes IN1-IN9 as shown in FIG. 9C, which meets input criteria of models WDU_01 and WDU_02. As such, system 800 selects, for model family Window & Door Upgrade Energy Savings′, a second subset of models including WDU_01 and WDU_02.

In a third example, model family Insulation Upgrade Energy Savings includes a first subset of models corresponding to the present region Nova Scotia 501d. Model family Insulation Upgrade Energy Savings has a first subset of models including models, IUES_01, IUES_02 and IUES_03 having input criteria of IN1-IN7, IN1-IN9, and IN1-IN24, respectively. Building-related data 938 includes IN1-IN9 as shown in FIG. 9C, which meets input criteria of models IUES_01 and IUES_02. As such, system 800 selects, for model family Insulation Upgrade Energy Savings′, a second subset of models including IUES_01 and IUES_02.

In a fourth example, model family Insulation Upgrade includes a first subset of models corresponding to the present region Nova Scotia 501d. Model family Insulation Upgrade has a first subset of models including models, IU_01, IU_02 and IU_03 having input criteria of IN1-IN1-IN7, IN1-IN9, and IN1-IN24, respectively. Building-related data 938 includes IN1-IN9 as shown in FIG. 9C, which meets input criteria of models IU_01 and IU_02. As such, system 800 selects, for model family Insulation Upgrade′, a second subset of models including IU_01 and IU_02.

System 800 processes remaining model families including a first subset of models corresponding to the present region Nova Scotia 501d in a similar manner as described above. System 800 selects a second subset of models including CUES_01 and CUES_02, CU_01 and CU_02, THEC_04 and THEC_05, and HEC_04 and HEC_05 corresponding to model families Ceiling Upgrade Energy Savings, Ceiling Upgrade, Total Home Energy Consumption and Heating Energy Consumption, respectively.

Next, at block 910, process 900A includes for each model family corresponding to the present service region, selecting a first model from the second subset of models based on a model score of the first model having a greater value compared to a model score of other models of the second subset of models.

In a first example, for model family Window & Door Upgrade Energy Savings the corresponding second subset of models includes models, WDES_01 and WDES_02 having scores 10 and 20 respectively. Model WDES_02 has a higher score than model WDES_01, as such system 800 selects WDES_02 as the first model, having a model score 20.

In a second example, for model family Window & Door Upgrade the corresponding second subset of models includes models, WDU_01 and WDU_02 having scores 10 and 20 respectively. Model WDU_02 has a higher score than model WDU_01, as such system 800 selects WDES_02 as the first model, having a model score 20.

System 800 selects first models for each of the remaining second subset of models corresponding to model families Insulation Upgrade Energy Savings′, Insulation Upgrade′, Ceiling Upgrade Energy Savings′, Ceiling Upgrade′, Total Home Energy Consumption and Heating Energy Consumption′, including models IUES_02, IU_02, CUES_02, CU_02, THEC_05 and HEC_05, each thereof, having a model score 20, respectively.

Next, at block 912, process 900A includes, for each model family of a plurality of model families corresponding to the present service region, determining if the model score of the first model exceeds the score of the final model. If the score of the first model exceeds the score of the final model, process 900A proceeds to block 914, otherwise it proceeds to block 916.

In a first example, for model family Window & Door Upgrade Energy Savings the final model score is 10 and the model score of the first model, WDES_02 is 20. As the model score of the first model exceeds the final model score process 900A proceeds to block 914.

In a second example, for model family Window & Door Upgrade the final model score is 10 and the model score of the first model, WDU_02 is 20. As the model score of the first model exceeds the final model score process 900A proceeds to block 914.

System 800 determines whether the remaining final model scores corresponding to each model family exceeds the score of first model. Model scores of a first model corresponding to model families Insulation Upgrade Energy Savings′, Insulation Upgrade′, Ceiling Upgrade Energy Savings′, Ceiling Upgrade′, Total Home Energy Consumption and Heating Energy Consumption′, are 20 which exceeds corresponding final model scores 10. As the model score of the first model exceeds the final model score process 900A proceeds to block 914.

Next, at block 914, process 900A includes for each model family of a plurality of model families corresponding to the present service region, modifying corresponding final model data including modifying final model ID data to be same as first model ID data and final model score data to be same as score data of the first model score data.

For example, the final model data corresponding to model family Window & Door Upgrade Energy Savings includes modifying Final Model ID data to indicate a same model ID as the first model WDES_02 and modifying Final Model Score data to indicate a same model score 20 as the first model WDES_02.

In another example, final model data corresponding to model family Window & Door Upgrade includes modifying Final Model ID data to indicate a same model ID as the first model WDU_02 and modifying Final Model Score data to indicate a same model score 20 as the first model WDU_02.

Final model data corresponding to model families Insulation Upgrade Energy Savings′, Insulation Upgrade′, Ceiling Upgrade Energy Savings′, Ceiling Upgrade′, Total Home Energy Consumption and Heating Energy Consumption′, are modified by system 800 in a similar manner to same first model data of model families Insulation Upgrade Energy Savings′, Insulation Upgrade′, Ceiling Upgrade Energy Savings′, Ceiling Upgrade′, Total Home Energy Consumption and Heating Energy Consumption′, respectively

Table 5 indicates the present value of final model data including final model ID data and final model score data for model families Window & Door Upgrade Energy Savings, Window & Door Upgrade, Insulation Upgrade Energy Savings, Insulation Upgrade Energy Savings, Insulation Upgrade, Ceiling Upgrade Energy Savings′, Ceiling Upgrade, Total Home Energy Consumption and Heating Energy Consumption′.

TABLE 5

| | Final | Final |
|---|---|---|
| | Model ID | Model Score |
| Window & Door Upgrade Energy Savings | WDES_02 | 20 |
| Window & Door Upgrade | WDU_02 | 20 |
| Insulation Upgrade Energy Savings | IUES_02 | 20 |
| Insulation Upgrade | IU_02 | 20 |
| Ceiling Upgrade Energy Savings | CUES_02 | 20 |
| Ceiling Upgrade | CU_02 | 20 |
| Total Home Energy Consumption | THEC_05 | 20 |
| Heating Energy Consumption | HEC_05 | 201 |

Next, at block 916, process 900A includes determining whether a next service region of the second plurality of service regions has an area subsequently larger in size in comparison to an area of the present service region. If so, process 900A proceeds to block 918, otherwise it proceeds to block 919.

For example, system 800 processes area data 724 corresponding to remaining service regions of second plurality of service regions, including Canada 500 having area 1 m sq km as shown in column 724 of table 720. In this example, service region Canada 500 having an area 1 m sq which is subsequently larger in size (i.e., area) compared to the area 55,284 sq km of present service region Nova Scotia 501d. As such, process 900A proceeds to block 918.

System 800 selects service region Canada 500 as the next service region.

At block 918, process 900A includes modifying present service region data to be same as next service region data and repeats blocks 906 to 912.

For example, system 800 modifies present service region data to indicate the next service region, Canada 500. Process 900A proceeds to block 906.

At block 906, process 900, includes, for each model family of a plurality of model families including a first subset of models corresponding to the present service region, provided final model data indicative of a final model other than exists, creating final model data for the model family. Final model data includes final model ID data indicative of a model ID of the final model and final model score data indicative of a score of the final model, and both final model ID data and final model score data have a value of 0′.

Only model families Total Home Energy Consumption and Heating Energy Consumption have a subset of models, including THEC_01, THEC_02, THEC_03 and HEC_01, HEC_02, HEC_03, respectively, corresponding to the present service region, Canada 500. As final model data has already been created for model families Total Home Energy Consumption and Heating Energy Consumption′, as shown in Table 5, system 800 proceeds to block 908.

Next, at block 908, process 900A includes for each model family of a plurality of model families including a first subset of models corresponding to the present service region, selecting a second subset of models therefrom based on the building-related data meeting input criteria of each thereof.

In a first example, a model family Total Home Energy Consumption includes a first subset of models corresponding to the present region Canada 500. Model family Total Home Energy Consumption has a first subset of models including models, THEC_01, THEC_02, and THEC_03, having input criteria of IN1-IN7, IN1-IN9, and IN1-IN24, respectively. Building-related data 938 includes IN1-IN9 shown in FIG. 9C, which meets input criteria of models THEC_01 and THEC_02. As such, system 800 selects for model family Total Home Energy Consumption′, a second subset of models including THEC_01 and THEC_02.

In a second example, a model family Heating Energy Consumption includes a first subset of models corresponding to the present region Canada 500. Model family Heating Energy Consumption has a first subset of models including HEC_01, HEC_2, and HEC_03, having input criteria of IN1-IN7, IN1-IN9 and IN1-IN24, respectively. Building-related data 938 includes IN1-IN9 as shown in FIG. 9C, which meets input criteria of models HEC_01 and HEC_02. As such, system 800 selects for model family Heating Energy Consumption′, a second subset of models including HEC_01 and HEC_02.

Next, at block 910, process 900A includes for each model family of a plurality of model families corresponding to the present service region, selecting a first model from the second subset of models based on a model score of the first model having a greater value compared to a model score of other models of the second subset of models.

In a first example, for model family Total Home Energy Consumption the second subset of models only includes THEC_01 and THEC_02, having a score 10 and 20 respectively. Model THEC_02 has a higher score than THEC_01. As such system 800 selects model THEC_02 as the first model for model family Total Home Energy Consumption′.

In a second example, for model family Heating Energy Consumption the second subset of models only includes HEC_01 and HEC_02, having a score 10 and 20 respectively. Model HEC_02 has a higher score than HEC_01. As such system 800 selects model HEC_02 as the first model for model family Heating Energy Consumption′.

Next, at block 912, process 900A includes, for each model family of a plurality of model families corresponding to the present service region, determining if the score of the first model exceeds the score of the final model. If the score of the first model exceeds the score of the final model, process 900A proceeds to block 914, otherwise it proceeds to block 916.

In a first example, for model family Total Home Energy Consumption the final model score of final model THEC_05 is 20 and the model score of the first model THEC_02 is 20. As such, the score of the first model does not exceed the score of the final model and process 900A proceeds to block 916.

In a first example, for model family Heating Energy Consumption the final model score is 20 and the model score of the first model HEC_02 is 20. As such, the model score of the first model HEC_02 does not exceed the final model score of model THEC_05 and process 900A proceeds to block 916.

Next, at block 916, process 900A includes determining whether a next service region of the second plurality of service regions has an area subsequently larger in size in comparison to an area of the present service region. If so, process 900A proceeds to block 918, otherwise it proceeds to block 919.

For example, system 800 processes area data 724 corresponding to other remaining service regions of second plurality of service regions not yet processed, however, there are no other service regions in the second plurality of service regions to be processed. As such, process 900A proceeds to block 919.

At block 919, process 900A includes, for each final model corresponding to each model family, processing building-related data by the final model, the final model for predicting an energy-related metric of a building. Predicting an energy-related metric of a building includes at least one of recommending a building upgrade and predicting an energy characteristic of a building.

In the present example, final models 923 corresponding to each model family 922 are shown in FIG. 9B. System 800 inputs building-related data 938 into each final model 923 for at least one of recommending a building upgrade and predicting an energy characteristic of building 516.

For example, system 800 inputs building-related data 938 into final model 923-1 model WDES_02 for providing a recommendation of a window and door upgrade. For instance, model WDES_02 provides an estimate of energy savings, for example in MJ, if window and doors of building 516 were upgraded to ENERGY STAR®.

In another example, system 800 inputs building-related data 938 into final model THEC_05 923-7 for predicting an energy characteristic of a building, the energy characteristic in the form of Total Home Energy Consumption. For instance, final model THEC_05 923-7 outputs a prediction of the total amount of energy, for example 100 GJ, consumed by building 926.

System 800 inputs building-related data 938 into remaining final models 923 including WDU_02 923-2, IUES_02 923-3, IU_02 923-4, FUES_02 923-5, FU_02 923-6, THEC-05 923-7 and HEC_05 923-8 for one of recommending a building upgrade and predicting an energy characteristic of building 516.

Finally, at block 920, process 900A includes, for each final model corresponding to each model family of the plurality of model families, providing indication data indicative predicting an energy-related metric of a building. Predicting an energy-related metric of a building includes at least one of recommending a building upgrade and predicting an energy characteristic of a building.

In a first example, system 800 creates indication data indicating the window and door upgrade energy savings and stores the indication data, for example, for future use.

Alternatively, system 800 transmits the indication data to a server accessible to a building owner. Further alternatively, system 800 provides the indication data via email, and/or text, and/or another electronic communication means.

For example, system 800 transmits indication data to a server accessible by an owner of the building. In some instance, system 800 may send indication data to an owner of a building in an email and/or text and/or by another electronic communication means.

Alternatively, an owner of a building logs into system 800 to retrieve the indication data. Further alternatively, system 800 transmits indication data to another system which an owner of a building logs into to retrieve indication data.

### Process 900B

According to an embodiment, there is a method for predicting an energy-related metric of a building. Predicting an energy-related metric of a building includes at least one of recommending a building upgrade and predicting an energy characteristic of a building.

Shown in FIG. 9D is simplified flow diagram of process 900B for predicting an energy-related metric of a building.

Process 900B is described as carried out by system 800 operating in network environment 801 shown in FIG. 8, described hereinabove. Process 900B is described below with reference to FIG. 4, FIG. 5A, FIG. 5C, FIG. 6, FIG. 7A, FIG. 7B, FIG. 7C, FIG. 8A, FIG. 9A, FIG. 9B, and FIG. 9C.

Starting at block 902, process 900B includes processing building-related data corresponding to a building and boundary data corresponding to a first plurality of service regions for selecting a second plurality of service regions.

For example, shown in FIG. 9C is exemplary building-related data 938 corresponding to building 518, in the form of a residential home, shown in FIG. 5C.

A diagrammatic view of exemplary boundary data 400 is shown in FIG. 4. Boundary data 400 corresponds to a first plurality of service regions including Canada 500, British Columbia 501a, Ontario 501b, New Brunswick 501c, Nova Scotia 501d shown in FIG. 5A, and Halifax 512 and Gas_Co_1 516 shown in FIG. 5C.

In the present example, building-related data 938 indicates that the home 518 is located on 321 First Street, Halifax, NS, Canada, B3M 4T2. System 800 converts the address of building 518 into LAT. LONG coordinates. For instance, system 800 transmits data indicating the address of the first home to a geocoding service based in the cloud and receives from the geocoding service data indicating coordinates of the first home to be (44.664689, −63.652102). System 800 creates Lat_Long1 data indicating LAT, LONG coordinates (44.664689, −63.652102).

Next system 800 processes Lat_Long1 data and boundary data 400 for identifying one or more services regions within which the building 518 is located. System 800 processes Lat_Long1 data and service region boundary files Canada.GeoJSON 402, British Columbia.GeoJSON 404, Ontario.GeoJSON 406, New Brunswick.GeoJSON 408, Nova Scotia.GeoJSON 410, Halifax.GeoJSON 412 and Gas_Co_1. GeoJSON 414, corresponding to service regions Canada 500, British Columbia 501a, Ontario 501b, New Brunswick 501c, Nova Scotia 501d, as shown in FIG. 5A, Halifax 512 and Gas_Co_1 516 shown in FIG. 5C, using, for example, a polygon function.

System 800 determines that building 518 is located within the following service regions, Canada 500, Nova Scotia 501d, Halifax 512 and Gas_Co_1 516.

System 800 selects service regions Canada 500, Nova Scotia 501d, Halifax 512 and Gas_Co_1 516 for forming a second plurality of service regions corresponding to building 518. System 800 also creates service region data indicative of service regions, Canada 500, Nova Scotia 501d, Halifax 512 and Gas_Co_1 516, and stores it, for example, in datastore 804.

Next at block 904, process 900B incudes selecting a present service region from the second plurality of service regions based on the present service region having an area smaller in size in comparison to an area of other service regions of the second plurality of service regions.

Exemplary service region data is shown in table 720 of FIG. 7A, FIG. 7B, and FIG. 7C, including service region ID data 722, indicating a unique ID for each of the second plurality of service regions and area data 724 indicating a size of the area of the corresponding service region in square kilometers.

Table 720 also includes exemplary Model Family ID data 726 indicating a unique ID for a model family corresponding to a service region. A model family corresponding to a service region includes a subset of models corresponding to the service region. Model ID data 728 indicates a unique ID for each model of a subset of models corresponding to the service region. Table 720 also includes score data 730 indicative of a score of a corresponding model as well as input criteria data 732 indicating required input data for employing a corresponding model. Exemplary input data is shown in table 600 of FIG. 6.

A model family may have subsets of models corresponding to one or more service regions. For example, model family Total Home Energy Consumption has a subset of models THEC_01, THEC_02 and THEC_03 corresponding service region Canada 500. Model family Total Home Energy Consumption also has a subset of models, THEC_04, THEC_05 and THEC_06 corresponding to service region Nova Scotia 501d, a subset of models, THEC_07 corresponding to service region Halifax 512, and a subset of models THEC_08 corresponding to service region Gas_Co_1 516.

System 800 processes area data 724 corresponding to the second plurality of service regions, Canada 500, Nova Scotia 501d, Halifax 512 and Gas_Co_1 516, having areas 1 m sq km, 55,284 sq km, 10,311 sq km, and 3001 sq km, respectively, as shown. In this example, service region Gas_Co_1 516 has the smallest area size, 3001 sq km of all of the second plurality of service regions. System 800 selects service region Gas_Co_1 516 as the present service region. System 800 creates present service region data to indicate service region Gas_Co_1 516.

Next, at block 905, process 900, includes, for each model family of a plurality of model families corresponding to the second plurality of service regions, creating final model data for the model family. Final model data includes final model ID data indicative of a model ID of the final model and final model score data indicative of a score of the final model, and both final model ID data and final model score data having a value of 0′.

In the present example, the plurality of model families associated with the second plurality of service regions Canada 500, Nova Scotia 501d, Halifax 512 and Gas_Co_1 516, includes, Window & Door Upgrade Energy Savings′, Window & Door Upgrade′, Insulation Upgrade Energy Savings′, Insulation Upgrade′, Ceiling Upgrade Energy Savings′, Ceiling Upgrade, Total Home Energy Consumption and Heating Energy Consumption′, shown in table 720.

However, only model families Ceiling Upgrade Energy Savings′, Ceiling Upgrade, Total Home Energy Consumption and Heating Energy Consumption have a first subset of models, including, CUES_01, CU_01, THEC_08 and HEC_08, respectively, corresponding to the present service region, Gas_Co_1 516. As no final model data has yet been created for model families Ceiling Upgrade Energy Savings′, Ceiling Upgrade, Total Home Energy Consumption and Heating Energy Consumption′, system 800 creates final model data for each thereof, including final model ID data and final model score data each having a value of 0′. Table 6 indicates the present value of model data for model families Ceiling Upgrade Energy Savings′, Ceiling Upgrade, Total Home Energy Consumption and Heating Energy Consumption′.

TABLE 6

| | Final | Final |
|---|---|---|
| | Model ID | Model Score |
| Window & Door Upgrade Energy Savings | 0 | 0 |
| Window & Door Upgrade | 0 | 0 |
| Insulation Upgrade Energy Saving | 0 | 0 |
| Insulation Upgrade | 0 | 0 |
| Ceiling Upgrade Energy Savings Final Model | 0 | 0 |
| Ceiling Upgrade Final Model | 0 | 0 |
| Total Home Energy Consumption Final Model | 0 | 0 |
| Heating Energy Consumption Final Model | 0 | 0 |

Next, at block 908, process 900B includes for each model family of a plurality of model families including a first subset of models corresponding to the present service region, selecting a second subset of models therefrom based on corresponding building-related data meeting input criteria of each thereof.

In a first example, model family Ceiling Upgrade Energy Savings includes a first subset of models corresponding to the present region Gas_Co_1. Model family Ceiling Upgrade Energy Savings has a first subset of models including only one model, CUES_05, having input criteria of IN1-IN7. Building-related data 938 includes IN1-IN9, as shown in FIG. 9C, which includes IN1-IN7 and thus meets input criteria of model CUES_05. As such, system 800 selects, for model family Ceiling Upgrade Energy Savings′, a second subset of models including model CUES_05 only.

In a second example, a model family Ceiling Upgrade includes a first subset of models corresponding to the present region Gas_Co_1. Model family Ceiling Upgrade has a first subset of models including only one model, CU_05, having input criteria of IN1-IN7. Building-related data 938 includes IN1-IN9, as shown in FIG. 9C, which includes IN1-IN7 and thus meets input criteria of model CU_05. As such, system 800 selects, for model family Ceiling Upgrade′, a second subset of models including model CU_05 only.

In a third example, a model family Total Home Energy Consumption includes a subset of models corresponding to the present region Gas_Co_1. Model family Total Home Energy Consumption has a first subset of models including only one model, THEC_08, having input criteria of IN1-IN7. Building-related data 938 includes IN1-IN9 as shown in FIG. 9C, which includes IN1-IN7 and thus meets input criteria of model THEC_08. As such, system 800 selects, for model family Total Home Energy Consumption′, a second subset of models including model THEC_08 only.

In a fourth example, a model family Heating Energy Consumption includes a first subset of models corresponding to the present region Gas_Co_1. Model family Heating Energy Consumption has a first subset of models including only one model, HEC_08, having input criteria of IN1-IN7. Building-related data 938 includes IN1-IN9 as shown in FIG. 9C, which includes IN1-IN7 and thus meets input criteria of model HEC_08. As such, system 800 selects, for model family Heating Energy Consumption′, a second subset of models including model HEC_08 only.

Next, at block 910, process 900B includes for each model family of a plurality of model families corresponding to the present service region, selecting a first model from the second subset of models based on a model score of the first model having a greater value compared to a model score of other models of the second subset of models.

In a first example, for model family Ceiling Upgrade Energy Savings the second subset of models only includes one model, CUES_05, having a score 10. There are no other model scores to compare to the score of model CUES_05. As such system 800 selects model CUES_05 as the first model for model family Ceiling Upgrade Energy Savings′.

System 800 processes the second subset of models for each of the other model families Ceiling Upgrade′, Total Home Energy Consumption′, and Heating Energy Consumption for selecting a corresponding first model. For similar reasoning as described above with respect to model family Ceiling Upgrade Energy Savings′, system 800 selects models CU_05, THEC_08, and HEC_08, each having a score of 10, for model families Ceiling Upgrade′, Total Home Energy Consumption′, and Heating Energy Consumption′, respectively.

Next, at block 912, process 900B includes, for each model family of a plurality of model families corresponding to the present service region, determining if the model score of the first model exceeds final score model data. If the model score of the first model exceeds the final model score, process 900B proceeds to block 914, otherwise it proceeds to block 916.

For example, for model family Total Home Energy Consumption the final model score is 0 and the model score of the first model THEC_08 is 10. As such, the model score of the first model THEC_08 exceeds the final model score 0, process 900B proceeds to block 914.

For model families Ceiling Upgrade′, Total Home Energy Consumption′, and Heating Energy Consumption each corresponding final model score is 0 and the model score of each corresponding first model is 10. As such, for each family, the model score of the first model exceeds the final model score, and process 900B also proceeds to block 914.

Next, at block 914, process 900B includes for each model family of a plurality of model families corresponding to the present service region, modifying corresponding final model data including modifying final model ID data to be same as first model ID data and final model score data to be same as score data of the first model score data.

For example, the final model data corresponding to model family Ceiling Upgrade Energy Savings includes modifying Final Model ID data to indicate a same model ID as the first model CUES_05 and modifying Final Model Score data to indicate a same model score 10 as the first model CUES_05.

In another example, final model data corresponding to model family Ceiling Upgrade includes modifying Final Model ID data to indicate a same model ID as the first model CU_05 and modifying Final Model Score data to indicate a same model score 10 as the first model CU_05.

In yet another example, final model data corresponding to model family Total Home Energy Consumption includes modifying Final Model ID data to indicate a same model ID as the first model THEC_08 and modifying Final Model Score data to indicate a same model score 10 as the first model THEC_08.

In a final example, the final model data corresponding to model family Heating Energy Consumption includes modifying Final Model ID data to indicate a same model ID as the first model HEC_08 and modifying Final Model Score data to indicate a same model score 10 as the first model HEC_08.

Table 7 indicates the present value of final model data including final model ID data and final model score data for model families Ceiling Upgrade Energy Savings′, Ceiling Upgrade, Total Home Energy Consumption and Heating Energy Consumption′.

TABLE 7

| | Final | Final |
|---|---|---|
| | Model ID | Model Score |
| Window & Door Upgrade Energy Savings | 0 | 0 |
| Window & Door Upgrade | 0 | 0 |
| Insulation Upgrade Energy Saving | 0 | 0 |
| Insulation Upgrade | 0 | 0 |
| Ceiling Upgrade Energy Savings Final Model | CUES_05 | 10 |
| Ceiling Upgrade Final Model | CU_05 | 10 |
| Total Home Energy Consumption Final Model | THEC_08 | 10 |
| Heating Energy Consumption Final Model | HEC_08 | 10 |

Next, at block 916, process 900B includes determining whether a next service region of the second plurality of service regions has an area subsequently larger in size in comparison to an area of the present service region. If so, process 900B proceeds to block 918, otherwise it proceeds to block 919.

For example, system 800 processes area data 724 corresponding to other service regions of second plurality of service regions, including Canada 500, Nova Scotia 501d, and Halifax 512 having areas 1 m sq km, 55,284 sq km, and 10,311 sq km, respectively, as shown in column 724 of table 720. In this example, service region Halifax 512 has an area 10,311 sq km which is the next subsequently larger service region in size (i.e., area) compared to the area 3001 sq km of present service region Gas_C0_1 516. As such, process 900B proceeds to block 918. System 800 selects service region Halifax 512 as the next service region.

At block 918, process 900B includes modifying present service region data to be same as next service region data and repeats blocks 908 to 912.

For example, system 800 modifies present service region data to indicate the next service region, Halifax 512. Process 900B then proceeds to block 909

Next, at block 908, process 900B includes for each model family of a plurality of model families including a first subset of models corresponding to the present service region, selecting a second subset of models therefrom based on the building-related data meeting input criteria of each thereof.

In a first example, model family Ceiling Upgrade Energy Savings includes a first subset of models corresponding to the present region Halifax 512. Model family Ceiling Upgrade Energy Savings has a first subset of models including only one model, CUES_04, having input criteria of IN1-IN7. Building-related data 938 includes IN1-IN9 as shown in FIG. 9C, which includes IN1-IN7 and thus meets input criteria of model CUES_04. As such, system 800 selects, for model family Ceiling Upgrade Energy Savings′, a second subset of models including CUES_04 only.

In a second example, model family Ceiling Upgrade includes a first subset of models corresponding to the present region Halifax 512. Model family Ceiling Upgrade has a first subset of models including only one model, CU_04, having input criteria of IN1-IN7. Building-related data 938 includes IN1-IN9 as shown in FIG. 9C, which includes IN1-IN7 and thus meets input criteria of model CU_04. As such, system 800 selects, for model family Ceiling Upgrade′, a second subset of models including CU_04 only.

In a third example, a model family Total Home Energy Consumption includes a first subset of models corresponding to the present region Halifax 512. Model family Total Home Energy Consumption has a first subset of models including only one model, THEC_07, having input criteria of IN1-IN7. Building-related data 938 includes IN1-IN9 as shown in FIG. 9C, which includes IN1-IN7 and thus meets input criteria of model THEC_07. As such, system 800 selects, for model family Total Home Energy Consumption′, a second subset of models including THEC_07 only.

In a fourth example, a model family Heating Energy Consumption includes a first subset of models corresponding to the present region Halifax 512. Model family Heating Energy Consumption has a first subset of models including only one model, HEC_07, having input criteria of IN1-IN7. Building-related data 938 includes IN1-IN9 as shown in FIG. 9C, which includes IN1-IN7 and thus meets input criteria of model HEC_07. As such, system 800 selects, for model family Heating Energy Consumption′, a second subset of models including HEC_07 only.

Next, at block 910, process 900B includes for each model family of a plurality of model families corresponding to the present service region, selecting a first model from the second subset of models based on a model score of the first model having a greater value compared to a model score of other models of the second subset of models.

In a first example, for model family Ceiling Upgrade Energy Savings the second subset of models only includes one model, CUES_04, having a score 10. There are no other model scores to compare to the score of model CUES_04. As such system 800 selects model CUES_04 as the first model for model family Ceiling Upgrade Energy Savings′.

System 800 processes the second subset of models for each of the other model families Ceiling Upgrade′, Total Home Energy Consumption′, and Heating Energy Consumption for selecting a corresponding first model. For similar reasoning as described above with respect to model family Ceiling Upgrade Energy Savings′, system 800 selects models U_04, THEC_07, and HEC_07, each having a score of 10, as the first model for model families Ceiling Upgrade′, Total Home Energy Consumption′, and Heating Energy Consumption′, respectively.

Next, at block 912, process 900B includes, for each model family of a plurality of model families corresponding to the present service region, determining if the model score of the first model exceeds final score model data. If the model score of the first model exceeds the final model score, process 900B proceeds to block 914, otherwise it proceeds to block 916.

For example, for model family Total Home Energy Consumption the final model score is 10 and the model score of the first model is 10. As such, the model score of the first model does not exceed the final model score, process 900B proceeds to block 916.

For model families Ceiling Upgrade′, Total Home Energy Consumption′, and Heating Energy Consumption each corresponding final model score is 10 and the model score of each corresponding first model is 10. As such, for each family, the model score of the first model does not exceed the final model score, and process 900B proceeds to block 916.

Next, at block 916, process 900B includes determining whether a next service region of the second plurality of service regions has an area subsequently larger in size in comparison to an area of the present service region. If so, process 900B proceeds to block 918, otherwise it proceeds to block 919.

For example, system 800 processes area data 724 corresponding to other service regions of second plurality of service regions, including Canada 500 and Nova Scotia 501d having areas 1 m sq km and 55,284 sq km, respectively, as shown in column 724 of table 720. In this example, service region Nova Scotia 501d has an area 55,284 sq km which is the next subsequently larger service region in size (i.e., area) compared to the area 10,311 sq km of present service region Halifax 512. As such, process 900B proceeds to block 918. System 800 selects service region Nova Scotia 501d as the next service region.

At block 918, process 900B includes modifying present service region data to be same as next service region data and repeats blocks 908 to 916.

For example, system 800 modifies present service region data to indicate the next service region, Nova Scotia 501d. Process 900B proceeds to block 908

Next, at block 908, process 900B includes for each model family of a plurality of model families including a first subset of models corresponding to the present service region, selecting a second subset of models therefrom based on the building-related data meeting input criteria of each thereof.

In a first example, model family Window & Door Upgrade Energy Savings includes a first subset of models corresponding to the present region Nova Scotia 501d. Model family Window & Door Upgrade Energy Savings has a first subset of models including models, WDES_01, WDES_02 and WDES_03 having input criteria of IN1-IN7, IN1-IN9, and IN1-IN24, respectively. Building-related data 938 includes IN1-IN9 as shown in FIG. 9C, which meets input criteria of models WDES_01 and WDES_02. As such, system 800 selects, for model family Window & Door Upgrade Energy Savings′, a second subset of models including WDES_01 and WDES_02.

In a second example, model family Window & Door Upgrade includes a first subset of models corresponding to the present region Nova Scotia 501d. Model family Window & Door Upgrade has a first subset of models including models, WDU_01, WDU_02 and WDU_03 having input criteria of IN1-IN7, IN1-IN9, and IN1-IN24, respectively. Building-related data 938 includes IN1-IN9 as shown in FIG. 9C, which meets input criteria of models WDU_01 and WDU_02. As such, system 800 selects, for model family Window & Door Upgrade Energy Savings′, a second subset of models including WDU_01 and WDU_02.

In a third example, model family Insulation Upgrade Energy Savings includes a first subset of models corresponding to the present region Nova Scotia 501d. Model family Insulation Upgrade Energy Savings has a first subset of models including models, IUES_01, IUES_02 and IUES_03 having input criteria of IN1-IN7, IN1-IN9, and IN1-IN24, respectively. Building-related data 938 includes IN1-IN9 as shown in FIG. 9C, which meets input criteria of models IUES_01 and IUES_02. As such, system 800 selects, for model family Insulation Upgrade Energy Savings′, a second subset of models including IUES_01 and IUES_02.

In a fourth example, model family Insulation Upgrade includes a first subset of models corresponding to the present region Nova Scotia 501d. Model family Insulation Upgrade has a first subset of models including models, IU_01, IU_02 and IU_03 having input criteria of IN1-IN1-IN7, IN1-IN9, and IN1-IN24, respectively. Building-related data 938 includes IN1-IN9 as shown in FIG. 9C, which meets input criteria of models IU_01 and IU_02. As such, system 800 selects, for model family Insulation Upgrade′, a second subset of models including IU_01 and IU_02.

System 800 processes remaining model families including a first subset of models corresponding to the present region Nova Scotia 501d in a similar manner as described above. System 800 selects a second subset of models including CUES_01 and CUES_02, CU_01 and CU_02, THEC_04 and THEC_05, and HEC_04 and HEC_05 corresponding to model families Ceiling Upgrade Energy Savings, Ceiling Upgrade, Total Home Energy Consumption and Heating Energy Consumption, respectively.

Next, at block 910, process 900B includes for each model family corresponding to the present service region, selecting a first model from the second subset of models based on a model score of the first model having a greater value compared to a model score of other models of the second subset of models.

In a first example, for model family Window & Door Upgrade Energy Savings the corresponding second subset of models includes models, WDES_01 and WDES_02 having scores 10 and 20 respectively. Model WDES_02 has a higher score than model WDES_01, as such system 800 selects WDES_02 as the first model, having a model score 20.

In a second example, for model family Window & Door Upgrade the corresponding second subset of models includes models, WDU_01 and WDU_02 having scores 10 and 20 respectively. Model WDU_02 has a higher score than model WDU_01, as such system 800 selects WDES_02 as the first model, having a model score 20.

System 800 selects first models for each of the remaining second subset of models corresponding to model families Insulation Upgrade Energy Savings′, Insulation Upgrade′, Ceiling Upgrade Energy Savings′, Ceiling Upgrade′, Total Home Energy Consumption and Heating Energy Consumption′, including models IUES_02, IU_02, CUES_02, CU_02, THEC_05 and HEC_05, each thereof, having a model score 20, respectively.

Next, at block 912, process 900B includes, for each model family of a plurality of model families corresponding to the present service region, determining if the model score of the first model exceeds the score of the final model. If the score of the first model exceeds the score of the final model, process 900B proceeds to block 914, otherwise it proceeds to block 916.

In a first example, for model family Window & Door Upgrade Energy Savings the final model score is 10 and the model score of the first model, WDES_02 is 20. As the model score of the first model exceeds the final model score process 900B proceeds to block 914.

In a second example, for model family Window & Door Upgrade the final model score is 10 and the model score of the first model, WDU_02 is 20. As the model score of the first model exceeds the final model score process 900B proceeds to block 914.

System 800 determines whether the remaining final model scores corresponding to each model family exceeds the score of first model. Model scores of a first model corresponding to model families Insulation Upgrade Energy Savings′, Insulation Upgrade′, Ceiling Upgrade Energy Savings′, Ceiling Upgrade′, Total Home Energy Consumption and Heating Energy Consumption′, are 20 which exceeds corresponding final model scores 10. As the model score of the first model exceeds the final model score process 900B proceeds to block 914.

Next, at block 914, process 900B includes for each model family of a plurality of model families corresponding to the present service region, modifying corresponding final model data including modifying final model ID data to be same as first model ID data and final model score data to be same as score data of the first model score data.

For example, the final model data corresponding to model family Window & Door Upgrade Energy Savings includes modifying Final Model ID data to indicate a same model ID as the first model WDES_02 and modifying Final Model Score data to indicate a same model score 20 as the first model WDES_02.

In another example, final model data corresponding to model family Window & Door Upgrade includes modifying Final Model ID data to indicate a same model ID as the first model WDU_02 and modifying Final Model Score data to indicate a same model score 20 as the first model WDU_02.

Final model data corresponding to model families Insulation Upgrade Energy Savings′, Insulation Upgrade′, Ceiling Upgrade Energy Savings′, Ceiling Upgrade′, Total Home Energy Consumption and Heating Energy Consumption′, are modified by system 800 in a similar manner to same first model data of model families Insulation Upgrade Energy Savings′, Insulation Upgrade′, Ceiling Upgrade Energy Savings′, Ceiling Upgrade′, Total Home Energy Consumption and Heating Energy Consumption′, respectively

Table 8 indicates the present value of final model data including final model ID data and final model score data for model families Ceiling Upgrade Energy Savings′, Ceiling Upgrade, Total Home Energy Consumption and Heating Energy Consumption′.

TABLE 8

| | Final | Final |
|---|---|---|
| | Model ID | Model Score |
| Window & Door Upgrade Energy Savings | WDES_02 | 20 |
| Window & Door Upgrade | WDU_02 | 20 |
| Insulation Upgrade Energy Savings' | IUES_02 | 20 |
| Insulation Upgrade' | IU_02 | 20 |
| Ceiling Upgrade Energy Savings Final | CUES_02 | 20 |
| Model | | |
| Ceiling Upgrade Final Model | CU_02 | 20 |
| Total Home Energy Consumption Final | THEC_05 | 20 |
| Model | | |
| Heating Energy Consumption Final Model | HEC_05 | 20 |

Next, at block 916, process 900B includes determining whether a next service region of the second plurality of service regions has an area subsequently larger in size in comparison to an area of the present service region. If so, process 900B proceeds to block 918, otherwise it proceeds to block 919.

For example, system 800 processes area data 724 corresponding to remaining service regions of second plurality of service regions, including Canada 500 having area 1 m sq km as shown in column 724 of table 720. In this example, service region Canada 500 having an area 1 m sq which is subsequently larger in size (i.e., area) compared to the area 55,284 sq km of present service region Nova Scotia 501d. As such, process 900B proceeds to block 918.

System 800 selects service region Canada 500 as the next service region.

At block 918, process 900B includes modifying present service region data to be same as next service region data and repeats blocks 908 to 912.

For example, system 800 modifies present service region data to indicate the next service region, Canada 500. Process 900B proceeds to block 908.

Next, at block 908, process 900B includes for each model family of a plurality of model families including a first subset of models corresponding to the present service region, selecting a second subset of models therefrom based on the building-related data meeting input criteria of each thereof.

In a first example, a model family Total Home Energy Consumption includes a first subset of models corresponding to the present region Canada 500. Model family Total Home Energy Consumption has a first subset of models including models, THEC_01, THEC_02, and THEC_03, having input criteria of IN1-IN7, IN1-IN9, and IN1-IN24, respectively. Building-related data 938 includes IN1-IN9 shown in FIG. 9C, which meets input criteria of models THEC_01 and THEC_02. As such, system 800 selects for model family Total Home Energy Consumption′, a second subset of models including THEC_01 and THEC_02.

In a second example, a model family Heating Energy Consumption includes a first subset of models corresponding to the present region Canada 500. Model family Heating Energy Consumption has a first subset of models including HEC_01, HEC_2, and HEC_03, having input criteria of IN1-IN7, IN1-IN9 and IN1-IN24, respectively. Building-related data 938 includes IN1-IN9 as shown in FIG. 9C, which meets input criteria of models HEC_01 and HEC_02. As such, system 800 selects for model family Heating Energy Consumption′, a second subset of models including HEC_01 and HEC_02.

Next, at block 910, process 900B includes for each model family of a plurality of model families corresponding to the present service region, selecting a first model from the second subset of models based on a model score of the first model having a greater value compared to a model score of other models of the second subset of models.

In a first example, for model family Total Home Energy Consumption the second subset of models only includes THEC_01 and THEC_02, having a score 10 and 20 respectively. Model THEC_02 has a higher score than THEC_01. As such system 800 selects model THEC_02 as the first model for model family Total Home Energy Consumption′.

In a second example, for model family Heating Energy Consumption the second subset of models only includes HEC_01 and HEC_02, having a score 10 and 20 respectively. Model HEC_02 has a higher score than HEC_01. As such system 800 selects model HEC_02 as the first model for model family Heating Energy Consumption′.

Next, at block 912, process 900B includes, for each model family of a plurality of model families corresponding to the present service region, determining if the score of the first model exceeds the score of the final model. If the score of the first model exceeds the score of the final model, process 900B proceeds to block 914, otherwise it proceeds to block 916.

In a first example, for model family Total Home Energy Consumption the final model score of final model THEC_05 is 20 and the model score of the first model THEC_02 is 20. As such, the score of the first model does not exceed the score of the final model and process 900B proceeds to block 916.

In a first example, for model family Heating Energy Consumption the final model score is 20 and the model score of the first model HEC_02 is 20. As such, the model score of the first model HEC_02 does not exceed the final model score of model THEC_05 and process 900B proceeds to block 916.

Next, at block 916, process 900B includes determining whether a next service region of the second plurality of service regions has an area subsequently larger in size in comparison to an area of the present service region. If so, process 900B proceeds to block 918, otherwise it proceeds to block 919.

For example, system 800 processes area data 724 corresponding to other remaining service regions of second plurality of service regions not yet processed, however, there are no other service regions in the second plurality of service regions to be processed. As such, process 900B proceeds to block 919.

At block 919, process 900B includes, for each final model corresponding to each model family, processing building-related data by the final model, the final model for predicting an energy-related metric of a building. Predicting an energy-related metric of a building includes at least one of recommending a building upgrade and predicting an energy characteristic of a building.

In the present example, final models 923 corresponding to each model family 922 are shown in FIG. 9B. System 800 inputs building-related data 938 into each final model 923 for at least one of recommending a building upgrade and predicting an energy characteristic of building 516.

For example, system 800 inputs building-related data 938 into final model 923-1 model WDES_02 for providing a recommendation of a window and door upgrade. For instance, model WDES_02 provides an estimate of energy savings, for example in MJ, if window and doors of building 516 were upgraded to ENERGY STAR®.

In another example, system 800 inputs building-related data 938 into final model THEC_05 923-7 for predicting an energy characteristic of a building, the energy characteristic in the form of Total Home Energy Consumption. For instance, final model THEC_05 923-7 outputs a prediction of the total amount of energy, for example 100 GJ, consumed by building 926.

System 800 inputs building-related data 938 into remaining final models 923 including WDU_02 923-2, IUES_02 923-3, IU_02 923-4, FUES_02 923-5, FU_02 923-6, THEC-05 923-7 and HEC_05 923-8 for one of recommending a building upgrade and predicting an energy characteristic of building 516.

Finally, at block 920, process 900B includes, for each final model corresponding to each model family of the plurality of model families, providing indication data indicative predicting an energy-related metric of a building. Predicting an energy-related metric of a building includes at least one of recommending a building upgrade and predicting an energy characteristic of a building.

In a first example, system 800 creates indication data indicating the window and door upgrade energy savings and stores the indication data, for example, for future use.

Alternatively, system 800 transmits the indication data to a server accessible to a building owner. Further alternatively, system 800 provides the indication data via email, and/or text, and/or another electronic communication means.

For example, system 800 transmits indication data to a server accessible by an owner of the building. In some instance, system 800 may send indication data to an owner of a building in an email and/or text and/or by another electronic communication means.

Alternatively, an owner of a building logs into system 800 to retrieve the indication data. Further alternatively, system 800 transmits indication data to another system which an owner of a building logs into to retrieve indication data.

### Process 1000

According to an embodiment, there is a method for predicting an energy-related metric of a building. Predicting an energy-related metric of a building includes at least one of recommending a building upgrade and predicting an energy characteristic of a building.

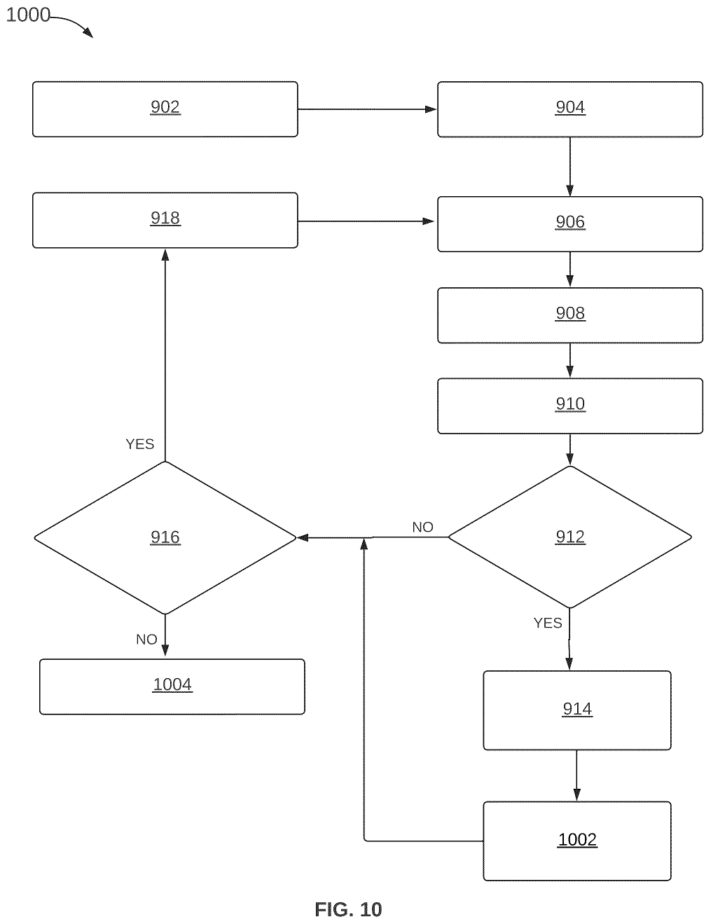

Shown in FIG. 10 is simplified flow diagram of process 1000 for predicting an energy-related metric of a building.

Process 1000 is described as carried out by system 800 operating in network environment 801 shown in FIG. 8, described hereinabove. Process 1000 is described below with reference to FIG. 4, FIG. 5A, FIG. 5C, FIG. 6, FIG. 7A, FIG. 7B, FIG. 7C, FIG. 8A, FIG. 9A, FIG. 9B, FIG. 9C and FIG. 10.

Starting at block 902, process 1000 includes processing building-related data corresponding to a building and boundary data corresponding to a first plurality of service regions for selecting a second plurality of service regions.

For example, shown in FIG. 9C is exemplary building-related data 938 corresponding to building 518, in the form of a residential home, shown in FIG. 5C.

A diagrammatic view of exemplary boundary data 400 is shown in FIG. 4. Boundary data 400 corresponds to a first plurality of service regions including Canada 500, British Columbia 501a, Ontario 501b, New Brunswick 501c, Nova Scotia 501d shown in FIG. 5A, and Halifax 512 and Gas_Co_1 516 shown in FIG. 5C.

In the present example, building-related data 938 indicates that the home 518 is located on 321 First Street, Halifax, NS, Canada, B3M 4T2. System 800 converts the address of building 518 into LAT. LONG coordinates. For instance, system 800 transmits data indicating the address of the first home to a geocoding service based in the cloud and receives from the geocoding service data indicating coordinates of the first home to be (44.664689, −63.652102). System 800 creates Lat_Long1 data indicating LAT, LONG coordinates (44.664689, −63.652102).

Next system 800 processes Lat_Long1 data and boundary data 400 for identifying one or more services regions within which the building 518 is located. System 800 processes Lat_Long1 data and service region boundary files Canada.GeoJSON 402, British Columbia.GeoJSON 404, Ontario.GeoJSON 406, New Brunswick.GeoJSON 408, Nova Scotia.GeoJSON 410, Halifax.GeoJSON 412 and Gas_Co_1. GeoJSON 414, corresponding to service regions Canada 500, British Columbia 501a, Ontario 501b, New Brunswick 501c, Nova Scotia 501d, as shown in FIG. 5A, Halifax 512 and Gas_Co_1 516 shown in FIG. 5C, using, for example, a polygon function.

System 800 determines that building 518 is located within the following service regions, Canada 500, Nova Scotia 501d, Halifax 512 and Gas_Co_1 516.

System 800 selects service regions Canada 500, Nova Scotia 501d, Halifax 512 and Gas_Co_1 516 for forming a second plurality of service regions corresponding to building 518. System 800 also creates service region data indicative of service regions, Canada 500, Nova Scotia 501d, Halifax 512 and Gas_Co_1 516, and stores it, for example, in datastore 804.

Next at block 904, process 1000 includes selecting a present service region from the second plurality of service regions based on the present service region having an area smaller in size in comparison to an area of other service regions of the second plurality of service regions.

Exemplary service region data is shown in table 720 of FIG. 7A, FIG. 7B, and FIG. 7C, including service region ID data 722, indicating a unique ID for each of the second plurality of service regions and area data 724 indicating a size of the area of the corresponding service region in square kilometers.

Table 720 also includes exemplary Model Family ID data 726 indicating a unique ID for a model family corresponding to a service region. A model family corresponding to a service region includes a subset of models corresponding to the service region. Model ID data 728 indicates a unique ID for each model of a subset of models corresponding to the service region. Table 720 also includes score data 730 indicative of a score of a corresponding model as well as input criteria data 732 indicating required input data for employing a corresponding model. Exemplary input data is shown in table 600 of FIG. 6.

A model family may have subsets of models corresponding to one or more service regions. For example, model family Total Home Energy Consumption has a subset of models THEC_01. THEC_02 and THEC_03 corresponding service region Canada 500. Model family Total Home Energy Consumption also has a subset of models, THEC_04, THEC_05 and THEC_06 corresponding to service region Nova Scotia 501d, a subset of models, THEC_07 corresponding to service region Halifax 512, and a subset of models THEC_08 corresponding to service region Gas_Co_1 516.

System 800 processes area data 724 corresponding to the second plurality of service regions, Canada 500, Nova Scotia 501d, Halifax 512 and Gas_Co_1 516, having areas 1 m sq km, 55,284 sq km. 10,311 sq km, and 3001 sq km, respectively, as shown. In this example, service region Gas_Co_1 516 has the smallest area size, 3001 sq km of the second plurality of service regions. System 800 selects service region Gas_Co_1 516 as the present service region. System 800 creates present service region data to indicate service region Gas_Co_1 516.

Next, at block 905, process 900, includes, for each model family of a plurality of model families corresponding to the second plurality of service regions, creating final model data for the model family. Final model data includes final model ID data indicative of a model ID of the final model and final model score data indicative of a score of the final model, and both final model ID data and final model score data having a value of 0′.

In the present example, the plurality of model families associated with the second plurality of service regions Canada 500, Nova Scotia 501d, Halifax 512 and Gas_Co_1 516, includes, Window & Door Upgrade Energy Savings′, Window & Door Upgrade′, Insulation Upgrade Energy Savings′, Insulation Upgrade′, Ceiling Upgrade Energy Savings′, Ceiling Upgrade, Total Home Energy Consumption and Heating Energy Consumption′, shown in table 720.

However, only model families Ceiling Upgrade Energy Savings′, Ceiling Upgrade, Total Home Energy Consumption and Heating Energy Consumption have a first subset of models, including, CUES_01, CU_01, THEC_08 and HEC_08, respectively, corresponding to the present service region, Gas_Co_1 516. As no final model data has yet been created for model families Ceiling Upgrade Energy Savings′, Ceiling Upgrade, Total Home Energy Consumption and Heating Energy Consumption′, system 800 creates final model data for each thereof, including final model ID data and final model score data each having a value of 0′. Table 9 indicates the present value of model data for model families Ceiling Upgrade Energy Savings′, Ceiling Upgrade, Total Home Energy Consumption and Heating Energy Consumption′.

TABLE 9

| | Final | Final |
|---|---|---|
| | Model ID | Model Score |
| Window & Door Upgrade Energy Savings | 0 | 0 |
| Window & Door Upgrade | 0 | 0 |
| Insulation Upgrade Energy Saving | 0 | 0 |
| Insulation Upgrade | 0 | 0 |
| Ceiling Upgrade Energy Savings | 0 | 0 |
| Ceiling Upgrade | 0 | 0 |
| Total Home Energy Consumption | 0 | 0 |
| Heating Energy Consumption | 0 | 0 |

Next, at block 908, process 1000 includes for each model family of a plurality of model families including a first subset of models corresponding to the present service region, selecting a second subset of models therefrom based on corresponding building-related data meeting input criteria of each thereof.

In a first example, model family Ceiling Upgrade Energy Savings includes a first subset of models corresponding to the present region Gas_Co_1. Model family Ceiling Upgrade Energy Savings has a first subset of models including only one model, CUES_05, having input criteria of IN1-IN7. Building-related data 938 includes IN1-IN9, as shown in FIG. 9C, which includes IN1-IN7 and thus meets input criteria of model CUES_05. As such, system 800 selects, for model family Ceiling Upgrade Energy Savings′, a second subset of models including model CUES_05 only.

In a second example, a model family Ceiling Upgrade includes a first subset of models corresponding to the present region Gas_Co_1. Model family Ceiling Upgrade has a first subset of models including only one model, CU_05, having input criteria of IN1-IN7. Building-related data 938 includes IN1-IN9, as shown in FIG. 9C, which includes IN1-IN7 and thus meets input criteria of model CU_05. As such, system 800 selects, for model family Ceiling Upgrade′, a second subset of models including model CU_05 only.

In a third example, a model family Total Home Energy Consumption includes a subset of models corresponding to the present region Gas_Co_1. Model family Total Home Energy Consumption has a first subset of models including only one model, THEC_08, having input criteria of IN1-IN7. Building-related data 938 includes IN1-IN9 as shown in FIG. 9C, which includes IN1-IN7 and thus meets input criteria of model THEC_08. As such, system 800 selects, for model family Total Home Energy Consumption′, a second subset of models including model THEC_08 only.

In a fourth example, a model family Heating Energy Consumption includes a first subset of models corresponding to the present region Gas_Co_1. Model family Heating Energy Consumption has a first subset of models including only one model, HEC_08, having input criteria of IN1-IN7. Building-related data 938 includes IN1-IN9 as shown in FIG. 9C, which includes IN1-IN7 and thus meets input criteria of model HEC_08. As such, system 800 selects, for model family Heating Energy Consumption′, a second subset of models including model HEC_08 only.

Next, at block 910, process 1000 includes for each model family of a plurality of model families corresponding to the present service region, selecting a first model from the second subset of models based on a model score of the first model having a greater value compared to a model score of other models of the second subset of models.

In a first example, for model family Ceiling Upgrade Energy Savings the second subset of models only includes one model, CUES_05, having a score 10. There are no other model scores to compare to the score of model CUES_05. As such system 800 selects model CUES_05 as the first model for model family Ceiling Upgrade Energy Savings′.

System 800 processes the second subset of models for each of the other model families Ceiling Upgrade′, Total Home Energy Consumption′, and Heating Energy Consumption for selecting a corresponding first model. For similar reasoning as described above with respect to model family Ceiling Upgrade Energy Savings′, system 800 selects models CU_05, THEC_08, and HEC_08, each having a score of 10, for model families Ceiling Upgrade′, Total Home Energy Consumption′, and Heating Energy Consumption′, respectively.

Next, at block 912, process 1000 includes, for each model family of a plurality of model families corresponding to the present service region, determining if the model score of the first model exceeds final score model data. If the model score of the first model exceeds the final model score, process 1000 proceeds to block 914, otherwise it proceeds to block 916.

For example, for model family Total Home Energy Consumption the final model score is 0 and the model score of the first model THEC_08 is 10. As such, the model score of the first model THEC_08 exceeds the final model score 0, process 1000 proceeds to block 914.

For model families Ceiling Upgrade′, Total Home Energy Consumption′, and Heating Energy Consumption each corresponding final model score is 0 and the model score of each corresponding first model is 10. As such, for each family, the model score of the first model exceeds the final model score, and process 1000 also proceeds to block 914.

Next, at block 914, process 1000 includes for each model family of a plurality of model families corresponding to the present service region, modifying corresponding final model data including modifying final model ID data to be same as first model ID data and final model score data to be same as score data of the first model score data.

For example, the final model data corresponding to model family Ceiling Upgrade Energy Savings includes modifying Final Model ID data to indicate a same model ID as the first model CUES_05 and modifying Final Model Score data to indicate a same model score 10 as the first model CUES_05.

In another example, final model data corresponding to model family Ceiling Upgrade includes modifying Final Model ID data to indicate a same model ID as the first model CU_05 and modifying Final Model Score data to indicate a same model score 10 as the first model CU_05.

In yet another example, final model data corresponding to model family Total Home Energy Consumption includes modifying Final Model ID data to indicate a same model ID as the first model THEC_08 and modifying Final Model Score data to indicate a same model score 10 as the first model THEC_08.

In a final example, the final model data corresponding to model family Heating Energy Consumption includes modifying Final Model ID data to indicate a same model ID as the first model HEC_08 and modifying Final Model Score data to indicate a same model score 10 as the first model HEC_08.

Table 10 indicates the present value of final model data including final model ID data and final model score data for model families Ceiling Upgrade Energy Savings′, Ceiling Upgrade, Total Home Energy Consumption and Heating Energy Consumption′.

TABLE 10

| | Final | Final |
|---|---|---|
| | Model ID | Model Score |
| Window & Door Upgrade Energy Savings | 0 | 0 |
| Window & Door Upgrade | 0 | 0 |
| Insulation Upgrade Energy Savings | 0 | 0 |
| Insulation Upgrade | 0 | 0 |
| Ceiling Upgrade Energy Savings | CUES_05 | 10 |
| Ceiling Upgrade | CU_05 | 10 |
| Total Home Energy Consumption | THEC_08 | 10 |
| Heating Energy Consumption | HEC_08 | 10 |

Next, at block 1002, process 1000 includes processing building-related data by the final model for each model of the plurality of model families corresponding to the second plurality of service regions. A final model for predicting an energy-related metric of a building.

In the present example, model families of the plurality of model families corresponding to the second plurality of service regions that have final model data are Ceiling Upgrade Energy Savings′, CUES_05, Ceiling Upgrade, CU_05, Total Home Energy Consumption′. THEC_08, and Heating Energy Consumption′, HEC_08. Model families of the plurality of model families corresponding to the second plurality of service regions that do not have final data include Window & Door Upgrade Energy Savings, Window & Door Upgrade Energy, Insulation Upgrade Energy Savings, and Insulation Upgrade, as shown in Table 10.

For example, system 800 inputs building-related data 938 into final model CUES_05 for predicting Ceiling Upgrade Energy Savings For instance, model CUES_05 provides an estimate of energy savings, for example in MJ, if ceiling insulation is upgraded. The output model CUES_05, a prediction of energy that would be saved if insulation was upgraded is stored, for example, in datastore 804.

In other examples, system 800 inputs building-related data 938 into final model CU_05, THEC_08, and HEC for predicting an energy-related metric of building 516. An indication of each energy-related metric of a building output by final models CU_05, THEC_08, and HEC, are stored, for example, in datastore 804, for future use.

Next, at block 916, process 1000 includes determining whether a next service region of the second plurality of service regions has an area subsequently larger in size in comparison to an area of the present service region. If so, process 1000 proceeds to block 918, otherwise it proceeds to block 1004.

For example, system 800 processes area data 724 corresponding to other service regions of second plurality of service regions, including Canada 500, Nova Scotia 501d, and Halifax 512 having areas 1 m sq km, 55,284 sq km, and 10,311 sq km, respectively, as shown in column 724 of table 720. In this example, service region Halifax 512 has an area 10,311 sq km which is the next subsequently larger service region in size (i.e., area) compared to the area 3001 sq km of present service region Gas_C0_1 516. As such, process 1000 proceeds to block 918. System 800 selects service region Halifax 512 as the next service region.

At block 918, process 1000 includes modifying present service region data to be same as next service region data and repeats blocks 908 to 912.

For example, system 800 modifies present service region data to indicate the next service region, Halifax 512. Process 1000 then proceeds to block 909

Next, at block 908, process 1000 includes for each model family of a plurality of model families including a first subset of models corresponding to the present service region, selecting a second subset of models therefrom based on the building-related data meeting input criteria of each thereof.

In a first example, model family Ceiling Upgrade Energy Savings includes a first subset of models corresponding to the present region Halifax 512. Model family Ceiling Upgrade Energy Savings has a first subset of models including only one model, CUES_04, having input criteria of IN1-IN7. Building-related data 938 includes IN1-IN9 as shown in FIG. 9C, which includes IN1-IN7 and thus meets input criteria of model CUES_04. As such, system 800 selects, for model family Ceiling Upgrade Energy Savings′, a second subset of models including CUES_04 only.

In a second example, model family Ceiling Upgrade includes a first subset of models corresponding to the present region Halifax 512. Model family Ceiling Upgrade has a first subset of models including only one model, CU_04, having input criteria of IN1-IN7. Building-related data 938 includes IN1-IN9 as shown in FIG. 9C, which includes IN1-IN7 and thus meets input criteria of model CU_04. As such, system 800 selects, for model family Ceiling Upgrade′, a second subset of models including CU_04 only.

In a third example, a model family Total Home Energy Consumption includes a first subset of models corresponding to the present region Halifax 512. Model family Total Home Energy Consumption has a first subset of models including only one model, THEC_07, having input criteria of IN1-IN7. Building-related data 938 includes IN1-IN9 as shown in FIG. 9C, which includes IN1-IN7 and thus meets input criteria of model THEC_07. As such, system 800 selects, for model family Total Home Energy Consumption′, a second subset of models including THEC_07 only.

In a fourth example, a model family Heating Energy Consumption includes a first subset of models corresponding to the present region Halifax 512. Model family Heating Energy Consumption has a first subset of models including only one model, HEC_07, having input criteria of IN1-IN7. Building-related data 938 includes IN1-IN9 as shown in FIG. 9C, which includes IN1-IN7 and thus meets input criteria of model HEC_07. As such, system 800 selects, for model family Heating Energy Consumption′, a second subset of models including HEC_07 only.

Next, at block 910, process 1000 includes for each model family of a plurality of model families corresponding to the present service region, selecting a first model from the second subset of models based on a model score of the first model having a greater value compared to a model score of other models of the second subset of models.

In a first example, for model family Ceiling Upgrade Energy Savings the second subset of models only includes one model, CUES_04, having a score 10. There are no other model scores to compare to the score of model CUES_04. As such system 800 selects model CUES_04 as the first model for model family Ceiling Upgrade Energy Savings′.

System 800 processes the second subset of models for each of the other model families Ceiling Upgrade′, Total Home Energy Consumption′, and Heating Energy Consumption for selecting a corresponding first model. For similar reasoning as described above with respect to model family Ceiling Upgrade Energy Savings′, system 800 selects models U_04, THEC_07, and HEC_07, each having a score of 10, as the first model for model families Ceiling Upgrade′, Total Home Energy Consumption′, and Heating Energy Consumption′, respectively.

Next, at block 912, process 1000 includes, for each model family of a plurality of model families corresponding to the present service region, determining if the model score of the first model exceeds final score model data. If the model score of the first model exceeds the final model score, process 1000 proceeds to block 914, otherwise it proceeds to block 916.

For example, for model family Total Home Energy Consumption the final model score is 10 and the model score of the first model is 10. As such, the model score of the first model does not exceed the final model score, process 1000 proceeds to block 916.

For model families Ceiling Upgrade′, Total Home Energy Consumption′, and Heating Energy Consumption each corresponding final model score is 10 and the model score of each corresponding first model is 10. As such, for each family, the model score of the first model does not exceed the final model score, and process 1000 proceeds to block 916.

Next, at block 916, process 1000 includes determining whether a next service region of the second plurality of service regions has an area subsequently larger in size in comparison to an area of the present service region. If so, process 1000 proceeds to block 918, otherwise it proceeds to block 1004.

For example, system 800 processes area data 724 corresponding to other service regions of second plurality of service regions, including Canada 500 and Nova Scotia 501d having areas 1 m sq km and 55,284 sq km, respectively, as shown in column 724 of table 720. In this example, service region Nova Scotia 501d has an area 55,284 sq km which is the next subsequently larger service region in size (i.e., area) compared to the area 10,311 sq km of present service region Halifax 512. As such, process 1000 proceeds to block 918. System 800 selects service region Nova Scotia 501d as the next service region.

At block 918, process 1000 includes modifying present service region data to be same as next service region data and repeats blocks 908 to 916.

For example, system 800 modifies present service region data to indicate the next service region, Nova Scotia 501d. Process 1000 proceeds to block 908

Next, at block 908, process 1000 includes for each model family of a plurality of model families including a first subset of models corresponding to the present service region, selecting a second subset of models therefrom based on the building-related data meeting input criteria of each thereof.

In a first example, model family Window & Door Upgrade Energy Savings includes a first subset of models corresponding to the present region Nova Scotia 501d. Model family Window & Door Upgrade Energy Savings has a first subset of models including models, WDES_01, WDES_02 and WDES_03 having input criteria of IN1-IN7, IN1-IN9, and IN1-IN24, respectively. Building-related data 938 includes IN1-IN9 as shown in FIG. 9C, which meets input criteria of models WDES_01 and WDES_02. As such, system 800 selects, for model family Window & Door Upgrade Energy Savings′, a second subset of models including WDES_01 and WDES_02.

In a second example, model family Window & Door Upgrade includes a first subset of models corresponding to the present region Nova Scotia 501d. Model family Window & Door Upgrade has a first subset of models including models, WDU_01, WDU_02 and WDU_03 having input criteria of IN1-IN7, IN1-IN9, and IN1-IN24, respectively. Building-related data 938 includes IN1-IN9 as shown in FIG. 9C, which meets input criteria of models WDU_01 and WDU_02. As such, system 800 selects, for model family Window & Door Upgrade Energy Savings′, a second subset of models including WDU_01 and WDU_02.

In a third example, model family Insulation Upgrade Energy Savings includes a first subset of models corresponding to the present region Nova Scotia 501d. Model family Insulation Upgrade Energy Savings has a first subset of models including models, IUES_01, IUES_02 and IUES_03 having input criteria of IN1-IN7, IN1-IN9, and IN1-IN24, respectively. Building-related data 938 includes IN1-IN9 as shown in FIG. 9C, which meets input criteria of models IUES_01 and IUES_02. As such, system 800 selects, for model family Insulation Upgrade Energy Savings′, a second subset of models including IUES_01 and IUES_02.

In a fourth example, model family Insulation Upgrade includes a first subset of models corresponding to the present region Nova Scotia 501d. Model family Insulation Upgrade has a first subset of models including models, IU_01, IU_02 and IU_03 having input criteria of IN1-IN1-IN7, IN1-IN9, and IN1-IN24, respectively. Building-related data 938 includes IN1-IN9 as shown in FIG. 9C, which meets input criteria of models IU_01 and IU_02. As such, system 800 selects, for model family Insulation Upgrade′, a second subset of models including IU_01 and IU_02.

System 800 processes remaining model families including a first subset of models corresponding to the present region Nova Scotia 501d in a similar manner as described above. System 800 selects a second subset of models including CUES_01 and CUES_02, CU_01 and CU_02. THEC_04 and THEC_05, and HEC_04 and HEC_05 corresponding to model families Ceiling Upgrade Energy Savings, Ceiling Upgrade, Total Home Energy Consumption and Heating Energy Consumption, respectively.

Next, at block 910, process 1000 includes for each model family corresponding to the present service region, selecting a first model from the second subset of models based on a model score of the first model having a greater value compared to a model score of other models of the second subset of models.

In a first example, for model family Window & Door Upgrade Energy Savings the corresponding second subset of models includes models, WDES_01 and WDES_02 having scores 10 and 20 respectively. Model WDES_02 has a higher score than model WDES_01, as such system 800 selects WDES_02 as the first model, having a model score 20.

In a second example, for model family Window & Door Upgrade the corresponding second subset of models includes models, WDU_01 and WDU_02 having scores 10 and 20 respectively. Model WDU_02 has a higher score than model WDU_01, as such system 800 selects WDES_02 as the first model, having a model score 20.

System 800 selects first models for each of the remaining second subset of models corresponding to model families Insulation Upgrade Energy Savings′, Insulation Upgrade′, Ceiling Upgrade Energy Savings′, Ceiling Upgrade′, Total Home Energy Consumption and Heating Energy Consumption′, including models IUES_02, IU_02, CUES_02, CU_02, THEC_05 and HEC_05, each thereof, having a model score 20, respectively.

Next, at block 912, process 1000 includes, for each model family of a plurality of model families corresponding to the present service region, determining if the model score of the first model exceeds the score of the final model. If the score of the first model exceeds the score of the final model, process 1000 proceeds to block 914, otherwise it proceeds to block 916.

In a first example, for model family Window & Door Upgrade Energy Savings the final model score is 10 and the model score of the first model, WDES_02 is 20. As the model score of the first model exceeds the final model score process 1000 proceeds to block 914.

In a second example, for model family Window & Door Upgrade the final model score is 10 and the model score of the first model, WDU_02 is 20. As the model score of the first model exceeds the final model score process 1000 proceeds to block 914.

System 800 determines whether the remaining final model scores corresponding to each model family exceeds the score of first model. Model scores of a first model corresponding to model families Insulation Upgrade Energy Savings′, Insulation Upgrade′, Ceiling Upgrade Energy Savings′, Ceiling Upgrade′, Total Home Energy Consumption and Heating Energy Consumption′, are 20 which exceeds corresponding final model scores 10. As the model score of the first model exceeds the final model score process 1000 proceeds to block 914.

Next, at block 914, process 1000 includes for each model family of a plurality of model families corresponding to the present service region, modifying corresponding final model data including modifying final model ID data to be same as first model ID data and final model score data to be same as score data of the first model score data.

For example, the final model data corresponding to model family Window & Door Upgrade Energy Savings includes modifying Final Model ID data to indicate a same model ID as the first model WDES_02 and modifying Final Model Score data to indicate a same model score 20 as the first model WDES_02.

In another example, final model data corresponding to model family Window & Door Upgrade includes modifying Final Model ID data to indicate a same model ID as the first model WDU_02 and modifying Final Model Score data to indicate a same model score 20 as the first model WDU_02.

Final model data corresponding to model families Insulation Upgrade Energy Savings′, Insulation Upgrade′, Ceiling Upgrade Energy Savings′, Ceiling Upgrade′, Total Home Energy Consumption and Heating Energy Consumption′, are modified by system 800 in a similar manner to same first model data of model families Insulation Upgrade Energy Savings′, Insulation Upgrade′, Ceiling Upgrade Energy Savings′, Ceiling Upgrade′, Total Home Energy Consumption and Heating Energy Consumption′, respectively.

Table 11 indicates the present value of final model data including final model ID data and final model score data for model families Ceiling Upgrade Energy Savings′, Ceiling Upgrade, Total Home Energy Consumption and Heating Energy Consumption′.

TABLE 11

| | Final | Final |
|---|---|---|
| | Model ID | Model Score |
| Window & Door Upgrade Energy Savings | WDES_02 | 20 |
| Window & Door Upgrade | WDU_02 | 20 |
| Insulation Upgrade Energy Savings' | IUES_02 | 20 |
| Insulation Upgrade' | IU_02 | 20 |
| Ceiling Upgrade Energy Savings Final | CUES_02 | 20 |
| Model | | |
| Ceiling Upgrade Final Model | CU_02 | 20 |
| Total Home Energy Consumption Final | THEC_05 | 20 |
| Model | | |
| Heating Energy Consumption Final Model | HEC_05 | 20 |

Next, at block 1002, process 1000 includes processing building-related data by the final model for each model of the plurality of model families corresponding to the second plurality of service regions. A final model for predicting an energy-related metric of a building.

In the present example, model families of the plurality of model families corresponding to the second plurality of service regions that have final model data are Window & Door Upgrade Energy Savings, model WDES_02, Window & Door Upgrade, model WDU_02, Insulation Upgrade Energy Savings, model IUES_02, and Insulation Upgrade, model IU_02, Ceiling Upgrade Energy Savings, model CUES_05, Ceiling Upgrade, model CU_05, Total Home Energy Consumption′, model THEC_05, and Heating Energy Consumption′, model HEC_05. Model families of the plurality of model families corresponding to the second plurality of service regions that do not have final data include Window & Door Upgrade Energy Savings, Window & Door Upgrade Energy, Insulation Upgrade Energy Savings, and Insulation Upgrade, as shown in Table 10.

For example, system 800 inputs building-related data 938 into final model WDES_02 for predicting Window & Door Upgrade Energy Savings. For instance, model WDES_02 provides an estimate of energy savings, for example in MJ, if doors and windows are upgraded to ENERGY STAR®. The output model WDES_02, a prediction of energy that would be saved if doors and windows are upgraded to ENERGY STAR® is stored, for example, in datastore 804, for future use.

In other examples, system 800 inputs building-related data 938 into all remaining final models of table 11 including Upgrade Energy, model WDU_02, Insulation Upgrade Energy Savings, model IUES_02, and Insulation Upgrade, model IU_02, Ceiling Upgrade Energy Savings, model CUES_05, Ceiling Upgrade, model CU_05, Total Home Energy Consumption′, model THEC_08, and Heating Energy Consumption′, model HEC_08. An indication of each energy-related metric of a building output by final models WDU_02, IUES_02, IU_02, CUES_02, CU_02, THEC_05, and HEC_05, are stored, for example, in datastore 804, for future use.

Next, at block 916, process 1000 includes determining whether a next service region of the second plurality of service regions has an area subsequently larger in size in comparison to an area of the present service region. If so, process 1000 proceeds to block 918, otherwise it proceeds to block 1004.

For example, system 800 processes area data 724 corresponding to remaining service regions of second plurality of service regions, including Canada 500 having area 1 m sq km as shown in column 724 of table 720. In this example, service region Canada 500 having an area 1 m sq which is subsequently larger in size (i.e., area) compared to the area 55,284 sq km of present service region Nova Scotia 501d. As such, process 1000 proceeds to block 918.

System 800 selects service region Canada 500 as the next service region.

At block 918, process 1000 includes modifying present service region data to be same as next service region data and repeats blocks 908 to 912.

For example, system 800 modifies present service region data to indicate the next service region, Canada 500. Process 1000 proceeds to block 908.

Next, at block 908, process 1000 includes for each model family of a plurality of model families including a first subset of models corresponding to the present service region, selecting a second subset of models therefrom based on the building-related data meeting input criteria of each thereof.

In a first example, a model family Total Home Energy Consumption includes a first subset of models corresponding to the present region Canada 500. Model family Total Home Energy Consumption has a first subset of models including models, THEC_01, THEC_02, and THEC_03, having input criteria of IN1-IN7, IN1-IN9, and IN1-IN24, respectively. Building-related data 938 includes IN1-IN9 shown in FIG. 9C, which meets input criteria of models THEC_01 and THEC_02. As such, system 800 selects for model family Total Home Energy Consumption′, a second subset of models including THEC_01 and THEC_02.

In a second example, a model family Heating Energy Consumption includes a first subset of models corresponding to the present region Canada 500. Model family Heating Energy Consumption has a first subset of models including HEC_01, HEC_2, and HEC_03, having input criteria of IN1-IN7, IN1-IN9 and IN1-IN24, respectively. Building-related data 938 includes IN1-IN9 as shown in FIG. 9C, which meets input criteria of models HEC_01 and HEC_02. As such, system 800 selects for model family Heating Energy Consumption′, a second subset of models including HEC_01 and HEC_02.

Next, at block 910, process 1000 includes for each model family of a plurality of model families corresponding to the present service region, selecting a first model from the second subset of models based on a model score of the first model having a greater value compared to a model score of other models of the second subset of models.

In a first example, for model family Total Home Energy Consumption the second subset of models only includes THEC_01 and THEC_02, having a score 10 and 20 respectively. Model THEC_02 has a higher score than THEC_01. As such system 800 selects model THEC_02 as the first model for model family Total Home Energy Consumption′.

In a second example, for model family Heating Energy Consumption the second subset of models only includes HEC_01 and HEC_02, having a score 10 and 20 respectively. Model HEC_02 has a higher score than HEC_01. As such system 800 selects model HEC_02 as the first model for model family Heating Energy Consumption′.

Next, at block 912, process 1000 includes, for each model family of a plurality of model families corresponding to the present service region, determining if the score of the first model exceeds the score of the final model. If the score of the first model exceeds the score of the final model, process 1000 proceeds to block 914, otherwise it proceeds to block 916.

In a first example, for model family Total Home Energy Consumption the final model score of final model THEC_05 is 20 and the model score of the first model THEC_02 is 20. As such, the score of the first model does not exceed the score of the final model and process 1000 proceeds to block 916.

In a first example, for model family Heating Energy Consumption the final model score is 20 and the model score of the first model HEC_02 is 20. As such, the model score of the first model HEC_02 does not exceed the final model score of model THEC_05 and process 1000 proceeds to block 916.

Next, at block 916, process 1000 includes determining whether a next service region of the second plurality of service regions has an area subsequently larger in size in comparison to an area of the present service region. If so, process 1000 proceeds to block 918, otherwise it proceeds to block 1004.

For example, system 800 processes area data 724 corresponding to other remaining service regions of second plurality of service regions not yet processed, however, there are no other service regions in the second plurality of service regions to be processed. As such, process 1000 proceeds to block 1004.

Finally, at block 1004, process 1000 includes, for each final model corresponding to each model family of the plurality of model families corresponding to the second plurality of service regions, providing indication data indicative of the most recent model thereof for predicting an energy-related metric of a building. Predicting an energy-related metric of a building includes at least one of recommending a building upgrade and predicting an energy characteristic of a building.

In a first example, model family Ceiling Upgrade Energy Savings Final Model has 2 different final models, including CUES_05 and CUES_02, however system 800 selects the output of the most recent model CUES_02 for providing an indication of energy that would be saved if windows and doors were upgrades to ENERGY STAR® for building 516.

Similarly, model families, Ceiling Upgrade, Total Home Energy Consumption, Heating Energy Consumption, have 2 final models, CU_05 & CU_02, THEC_08 & THEC_05, HEC_08 & HEC_05, respectively. However, system 800 selects the output of the most recent final model CU_02, THEC_05, for HEC_05, for providing an indication of an energy-related metric of building 516.

In a first example, system 800 creates indication data indicating the window and door upgrade energy savings and stores the indication data, for example, for future use.

Alternatively, system 800 transmits the indication data to a server accessible to a building owner. Further alternatively, system 800 provides the indication data via email, and/or text, and/or another electronic communication means.

For example, system 800 transmits indication data to a server accessible by an owner of the building. In some instance, system 800 may send indication data to an owner of a building in an email and/or text and/or by another electronic communication means.

Alternatively, an owner of a building logs into system 800 to retrieve the indication data. Further alternatively, system 800 transmits indication data to another system which an owner of a building logs into to retrieve indication data.

### Process 1100

According to an embodiment, there is another exemplary method for at least predicting an energy-related metric of a building. Predicting an energy-related metric of a building includes at least one of recommending a building upgrade and predicting an energy characteristic of a building.

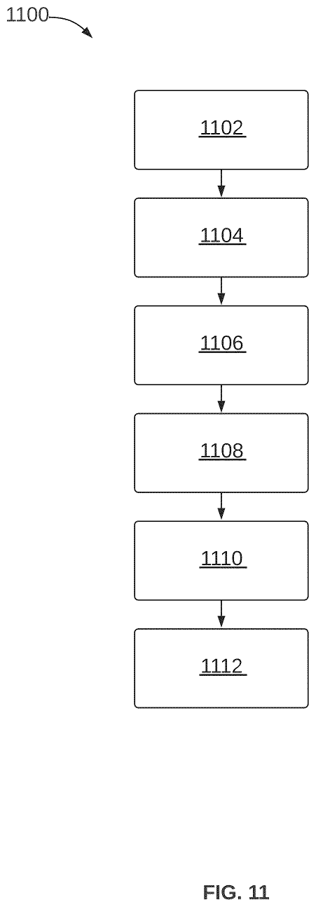

Shown in FIG. 11 is simplified flow diagram of process 1100 for one of predicting an energy characteristic of a building and recommending an upgrade of a building.

Process 1100 is described as carried out by system 800 operating in network environment 801 shown in FIG. 8, described hereinabove. Process 1100 is described below with reference to FIG. 4, FIG. 5A, FIG. 5B, FIG. 5C, FIG. 6, FIG. 7A, FIG. 7B, FIG. 7C, FIG. 8A, FIG. 9A and FIG. 9C. CHECK.

Starting at block 1102, process 1100 includes processing building-related data corresponding to a building and boundary data corresponding to a first plurality of service regions for determining a second plurality of service regions corresponding to the building.

For example, shown in FIG. 9C is exemplary building-related data 938 corresponding to building 518, as residential home, as shown in FIG. 5C.

Exemplary boundary data 400 corresponds to first plurality of service regions including Canada 500, British Columbia 501a, Ontario 501b, New Brunswick 501c, Nova Scotia 501d as shown in FIG. 5A, and Halifax 512 and Gas_Co_1 516 shown in FIG. 5C.

In the present example, building-related data 938 indicates that the home 518 is located on 321 First Street, Halifax, NS, Canada, B3M 4T2. System 800 converts the address of building 518 into LAT. LONG coordinates. For instance, system 800 transmits data indicating the address of the first home to a geocoding service based in the cloud and receives from the geocoding service data indicating coordinates of the first home to be (44.664689, −63.652102). System 800 creates Lat_Long1 data indicating LAT, LONG coordinates (44.664689, −63.652102).

Next system 800 processes Lat_Long1 data and boundary data 400 for identifying one or more services regions within which the building 518 is located. System 800 processes Lat_Long1 data and service region boundary files Canada.GeoJSON 402, British Columbia.GeoJSON 404, Ontario.GeoJSON 406, New Brunswick.GeoJSON 408, Nova Scotia.GeoJSON 410, Halifax.GeoJSON 412 and Gas_Co_1. GeoJSON 414, corresponding to service regions Canada 500, British Columbia 501a, Ontario 501b, New Brunswick 501c, Nova Scotia 501d, as shown in FIG. 5A, Halifax 512 and Gas_Co_1 516 shown in FIG. 5C, using, for example, a polygon function.

System 800 determines that building 518 is located within Canada 500, Nova Scotia 501d, Halifax 512 and Gas_Co_1 516, service regions.

System 800 selects service regions Canada 500, Nova Scotia 501d, Halifax 512 and Gas_Co_1 516 for forming a second plurality of service regions corresponding to building 518. System 800 also creates second plurality of service region data indicative of service regions Canada 500, Nova Scotia 501d, Halifax 512 and Gas_Co_1 516, and store it, for example, in datastore 804.

Next at block 1104, process 1100 includes, for each model family of a plurality of model families having one or more first subsets of models corresponding to the second plurality of service regions, selecting a second subset of models from the one or more first subsets of models corresponding to the second plurality of service regions based on the building-related data meeting input criteria of each thereof.

For example, system 800 processes data in table 720 for determining model family Total Home Energy Consumption has 4 first subsets of models corresponding to the second plurality of service regions, Canada 500, Nova Scotia 501d, Halifax 512 and Gas_Co_1 516.

For instance, model family Total Home Energy Savings includes a first subset of models, THEC_01, THEC_02 and THEC_03 corresponding to service region Canada 500, THEC_04, THEC_05 and THEC_06 corresponding to service region Nova Scotia 501d, THEC_07 corresponding to service region Halifax 512, and THEC_07 corresponding to service region Gas_Co_1 516.

System 800 processes building-related data 938, model ID data 728 and input criteria data 732 corresponding to subsets of models, THEC_01, THEC_02 and THEC_03 corresponding to service region Canada 500, THEC_04, THEC_05 and THEC_06 corresponding to service region Nova Scotia 501d, THEC_07 corresponding to service region Halifax 512, and THEC_08 corresponding to service region Gas_Co_1 516 for determining which thereof building-related data 938 meets their criteria.

Building-related data 938 includes IN1-IN7, IN9 and IN11, as shown in FIG. 9C. Models THEC_01, THEC_04, THEC_07 and THEC_08 have input criteria including IN1-IN7, models THEC_02 and THEC_05 have input criteria including IN1-IN7, IN9 and IN11 models THEC_03 and THEC_06 have input criteria including IN1-IN29. Building-related data 938, including IN1-IN7, IN9 and IN11, meets input criteria of models THEC_01, THEC_04, THEC_07 and THEC_08 have input criteria including IN1-IN7, models THEC_02 and THEC_05 have input criteria including IN1-IN7, IN9 and IN11. System 800 selects models THEC_01, THEC_04, THEC_07, THEC_08. THEC_02 and THEC_05 as the second subset of models corresponding to model family Total Home Energy Savings′.

System 800 selects a second subset of models from the one or more first subsets of models of each of the remaining model families corresponding to the second plurality of service regions in a similar manner as described above.

Next, at block 1106, process 1100 includes, for each model family of a plurality of model families having one or more first subsets of models corresponding to the second plurality of service regions, selecting a third subset of models from the second subset of models based on the third subset of models having a greatest score in comparison to scores of other models of the second subset of models.

For example, system 800 processes model score data 730 corresponding to the second subset of models corresponding to model family Total Home Energy Savings′. For instance, models THEC_01, THEC_04, THEC_07, THEC_08, THEC_02 and THEC_05 haves model scores 10, 10, 10, 10, 20 and 20, respectively. Models THEC_02 and THEC_05 have the highest model scores in comparison to other models in the second subset of models. System 800 selects models THEC_02 and THEC_05 as the third subset of models.

System 800 selects a third subset of models from a second subset of models corresponding to each model family in a similar manner as described above.

At block 1108, process 1100 includes for each model family of a plurality of model families having one or more first subsets of models corresponding to the second plurality of service regions, selecting a final model from the third subset of models based on the final model corresponding to a service region of the second plurality of service regions having an area smallest in size in comparison to other services areas of the second plurality of service regions.

For example, for the model family Total Home Energy Savings system 800 processes area data 724 corresponding to the service region associated with each model of the third plurality of models. Area data 724 of service area Canada 500 associated with model THEC_02 indicates an area of 1 m sq km, area data of service area Nova Scotia 501d associated with model THEC_05 indicates an area of 55,284 sq km. Model THEC_05 has a smaller area than model THEC_02. System 800 select model THEC_05 as the final model corresponding to model family Total Home Energy Savings′.

System 800 selects a final model from a third subset of models corresponding to each model family in a similar manner as described above.

At block 1110, process 1100 for each final model corresponding to each model family of the second plurality of model families, processing building-related data by the final model, the final model for one of recommending a building upgrade and predicting an energy characteristic of a building.

In the present example, final models 923 corresponding to each model family 922 are shown in FIG. 9B. System 800 inputs building-related data 938 into each final model 923 for predicting an energy-related metric of building 516.

For example, system 800 inputs building-related data 938 into final model 923-1 model WDES_02 for providing a recommendation of a window and door upgrade. For instance, model WDES_02 provides an estimate of energy savings, for example in MJ, if window and doors of building 516 were upgraded to EnerStar® window and doors,

In another example, system 800 inputs building-related data 938 into final model THEC_02 923-7 for predicting an energy characteristic of a building, the energy characteristic in the form of Total Home Energy Consumption. For instance, final model THEC_02 923-7 outputs a prediction of the total amount of energy, for example 100 MJ, consumed by building 926.

System 800 inputs building-related data 938 into remaining final models 923 including WDU_02 923-2, IUES_02 923-3, IU_02 923-4, FUES_02 923-5, FU_02 923-6 and THEC-05 923-7 for one of recommending a building upgrade and predicting an energy characteristic of building 516.

Finally, at block 1112, for each final model corresponding to each model family of the plurality of model families, providing indication data of an energy-related metric of a building.]

For example, system 800 transmits the indication data to a server accessible to a building owner. Further alternatively, system 800 provides the indication data via email, and/or text, and/or another electronic communication means.

For example, system 800 transmits indication data to a server accessible by an owner of the building. In some instance, system 800 may send indication data to an owner of a building in an email and/or text and/or by another electronic communication means.

Alternatively, an owner of a building logs into system 800 to retrieve the indication data. Further alternatively, system 800 transmits indication data to another system which an owner of a building logs into to retrieve indication data.

Included in the discussion above are a series of flow charts showing the steps and acts of various processes. The processing and decision blocks of the flow charts above represent steps and acts that may be included in algorithms that carry out these various processes. Algorithms derived from these processes may be implemented as software integrated with and directing the operation of one or more processors, may be implemented as functionally-equivalent circuits such as a Digital Signal Processing (DSP) circuit, a Field Programmable Gate Array (FPGA), an Application-Specific Integrated Circuit (ASIC), or may be implemented in any other suitable manner. It should be appreciated that the flow charts included herein do not depict the syntax or operation of any circuit or of any programming language or type of programming language. Rather, the flow charts illustrate the functional information one skilled in the art may use to fabricate circuits or to implement computer software algorithms to perform the processing of an apparatus carrying out the types of techniques described herein. It should also be appreciated that, unless otherwise indicated herein, the sequence of steps and/or acts described in each flow chart is merely illustrative of the algorithms that may be implemented and can be varied in implementations and embodiments of the principles described herein.

Accordingly, in some embodiments, the techniques described herein may be embodied in computer-executable instructions implemented as software, including as application software, system software, firmware, middleware, embedded code, or any other suitable type of computer code. Such computer-executable instructions may be written using any of several suitable programming languages and/or programming or scripting tools and may be compiled as executable machine language code or intermediate code that is executed on a framework or virtual machine.

Computer-executable instructions implementing the techniques described herein may, in some embodiments, be encoded on one or more computer-readable media to provide functionality to the media. Computer-readable media include magnetic media such as a hard disk drive, optical media such as a Compact Disk (CD) or a Digital Versatile Disk (DVD), Blu-Ray disk, a persistent or non-persistent solid-state memory (e.g., Flash memory, Magnetic RAM, etc.), or any other suitable storage media. As used herein, “computer-readable media” (also called “computer-readable storage media”) refers to tangible storage media. Tangible storage media are non-transitory and have at least one physical, structural component. In a “computer-readable medium,” as used herein, at least one physical, structural component has at least one physical property that may be altered in some way during a process of creating the medium with embedded information, a process of recording information thereon, or any other process of encoding the medium with information. For example, a magnetization state of a portion of a physical structure of a computer-readable medium may be altered during a recording process.

Embodiments have been described where the techniques are implemented in circuitry and/or computer-executable instructions. It should be appreciated that some embodiments may be in the form of a method or process, of which at least one example has been provided. The acts performed as part of the method or process may be ordered in any suitable way. Accordingly, embodiments may be constructed in which acts are performed in an order different than illustrated, which may include performing some acts simultaneously, even though shown as sequential acts in illustrative embodiments. Various aspects of the embodiments described above may be used alone, in combination, or in a variety of arrangements not specifically discussed in the embodiments described in the foregoing and is therefore not limited in its application to the details and arrangement of components set forth in the foregoing description or illustrated in the drawings. For example, aspects described in one embodiment may be combined in any manner with aspects described in other embodiments.

It should be understood that aspects are described herein with reference to certain illustrative embodiments. The illustrative embodiments described herein are not necessarily intended to show all aspects, but rather are used to describe a few illustrative embodiments. Thus, aspects described herein are not intended to be construed narrowly in view of the illustrative embodiments. In addition, it should be understood that certain features disclosed herein might be used alone or in any suitable combination with other features.

### Technical Effects

Embodiments described herein provide one or more technical effects and improvements to home energy efficiency home evaluations. For example, an automated system can perform large volumes of home energy efficiency evaluations without involvement of the homeowner and without a need for an onsite home evaluation. Energy metrics and upgrade recommendations can be quickly and automatically provided to many homeowners, enabling them to take upgrade action sooner in comparison to a manual onsite home evaluation.

What is claimed is:

1. A method for predicting an energy-related metric for a building comprising:
a) processing building-related data corresponding to a building and boundary data corresponding to a first plurality of service regions for selecting a second plurality of service regions therefrom, the second plurality of service regions corresponding to the building;
b) selecting a present service region from the second plurality of service regions based on the present service region having an area smaller in size in comparison to an area of other service regions of the second plurality of service regions;
c) for each model family of a plurality of model families including a first subset of models corresponding to the present service region,
i) provided final model data corresponding to the model family other than exists, creating final model data including final model ID data indicative of a final model ID and final model score data indicative of a score of the final model, the final model ID data and final model score data indicating a value of 0;
ii) selecting a second subset of models from the first subset of models based on the building-related data meeting input criteria of each thereof;
iii) selecting a first model from the second subset of models based on a model score of the first model having a greater value compared to a model score of other models of the second subset of models;
iv) provided the model score of the first model exceeds final score model data, modifying final model data including modifying final model ID data to be same as model ID data corresponding to the first model and final model score data to be same as model score data corresponding to the first model;
d) provided a next service region of the second plurality of service regions has an area subsequently larger in size in comparison to an area of the present service region, modifying the present service region to be same as the next service region and reiterating steps c and d); and
e) for each final model corresponding to each model family of the plurality of model families, processing building-related data by the final model, the final model for predicting an energy-related metric for a building comprising; and
f) for each final model corresponding to each model family of the plurality of model families, providing indication data indicative of a prediction of an energy-related metric for the building.

2. The method of claim 1 wherein processing building-related data corresponding to a building and boundary data corresponding to a first plurality of service regions for selecting a second plurality of service regions therefrom includes processing building-related data including an indication of a location of the building.

3. The method of claim 1 wherein predicting an energy-related metric of a building includes at least one of recommending a building upgrade and predicting an energy characteristic of a building.

4. The method of claim 1 wherein the model for predicting for predicting an energy-related metric for a building is created using a machine learning technique.

5. The method of claim 1 wherein the model for predicting for predicting an energy-related metric for a building is physics model.

6. The method of claim 3 wherein a model for predicting an energy characteristic of a building includes a model for predicting an energy characteristic of a building prior to an implementation of an upgrade to the building.

7. The method of claim 3 wherein a model for predicting an energy characteristic of a building includes a model for predicting an energy characteristic of a building after an upgrade to a building is implemented.

8. The method of claim 3 wherein a model for predicting an energy characteristic of a building includes a model for predicting energy saving for a building due to implementation of an upgrade.

9. A method for predicting an energy-related metric for a building comprising:
a) processing building-related data corresponding to a building and boundary data corresponding to a first plurality of service regions for selecting a second plurality of service regions therefrom, the second plurality of service regions corresponding to the building;
b) selecting a present service region from the second plurality of service regions based on the present service region having an area smaller in size in comparison to an area of other service regions of the second plurality of service regions;
c) for each model family corresponding to the second plurality of service regions, creating final model data including final model ID data indicative of a final model ID and final model score data indicative of a score of the final model, the final model ID data and final model score data indicating a value of 0;
d) for each model family of a plurality of model families including a first subset of models corresponding to the present service region,
i) selecting a second subset of models from the first subset of models based on the building-related data meeting input criteria of each thereof;
ii) selecting a first model from the second subset of models based on a model score of the first model having a greater value compared to a model score of other models of the second subset of models;
iii) provided the model score of the first model exceeds final score model data, modifying final model data including modifying final model ID data to be same as model ID data corresponding to the first model and final model score data to be same as model score data corresponding to the first model;
e) provided a next service region of the second plurality of service regions has an area subsequently larger in size in comparison to an area of the present service region, modifying the present service region to be same as the next service region and reiterating steps c and d); and
f) for each final model corresponding to each model family of the plurality of model families, processing building-related data by the final model, the final model for predicting an energy-related metric for a building comprising; and
g) for each final model corresponding to each model family of the plurality of model families, providing indication data indicative of a prediction of an energy-related metric for the building.

10. The method of claim 9 wherein processing building-related data corresponding to a building and boundary data corresponding to a first plurality of service regions for selecting a second plurality of service regions therefrom includes processing building-related data including an indication of a location of the building.

11. The method of claim 9 wherein predicting an energy-related metric of a building includes at least one of recommending a building upgrade and predicting an energy characteristic of a building.

12. The method of claim 9 wherein the model for predicting for predicting an energy-related metric for a building is created using a machine learning technique.

13. The method of claim 9 wherein the model for predicting for predicting an energy-related metric for a building is physics model.

14. The method of claim 11 wherein a model for predicting an energy characteristic of a building includes a model for predicting an energy characteristic of a building prior to an implementation of an upgrade to the building.

15. The method of claim 11 wherein a model for predicting an energy characteristic of a building includes a model for predicting an energy characteristic of a building after an upgrade to a building is implemented.

16. The method of claim 11 wherein a model for predicting an energy characteristic of a building includes a model for predicting energy saving for a building due to implementation of an upgrade.

17. A system configured for,
a) processing building-related data corresponding to a building and boundary data corresponding to a first plurality of service regions for selecting a second plurality of service regions therefrom, the second plurality of service regions corresponding to the building;
b) selecting a present service region from the second plurality of service regions based on the present service region having an area smaller in size in comparison to an area of other service regions of the second plurality of service regions;
c) for each model family corresponding to the second plurality of service regions, creating final model data including final model ID data indicative of a final model ID and final model score data indicative of a score of the final model, the final model ID data and final model score data indicating a value of 0;
d) for each model family of a plurality of model families including a first subset of models corresponding to the present service region,
i) selecting a second subset of models from the first subset of models based on the building-related data meeting input criteria of each thereof;
ii) selecting a first model from the second subset of models based on a model score of the first model having a greater value compared to a model score of other models of the second subset of models;
iii) provided the model score of the first model exceeds final score model data, modifying final model data including modifying final model ID data to be same as model ID data corresponding to the first model and final model score data to be same as model score data corresponding to the first model;
e) provided a next service region of the second plurality of service regions has an area subsequently larger in size in comparison to an area of the present service region, modifying the present service region to be same as the next service region and reiterating steps c and d); and
f) for each final model corresponding to each model family of the plurality of model families, processing building-related data by the final model, the final model for predicting an energy-related metric for a building comprising; and
g) for each final model corresponding to each model family of the plurality of model families, providing indication data indicative of a prediction of an energy-related metric for the building.

18. The system of claim 17 wherein providing indication data indicative of a prediction of an energy-related metric for the building includes providing indication data to a server accessible by a building owner.

19. The system of claim 17 wherein providing indication data indicative of a prediction of an energy-related metric for the building includes providing indication data by sending indication data by text and/or email.

20. The system of claim 17 further configured for a building owner to log into the system to retrieve indication data indicative of a prediction of an energy-related metric for the building.
